(19) United States
(12) Patent Application Publication
(10) Pub. No.: US 2023/0119208 A1
(43) Pub. Date: Apr. 20, 2023

(54) Sponsorship Exposure Metric System

(71) Applicant: Blinkfire Analytics, Inc., Chicago, IL (US)

(72) Inventors: Nan Jiang, Lincolnshire, IL (US); Stephen Joseph Olechowski, III, Glen Ellyn, IL (US); Ashwin Krishnaswami, Chicago, IL (US); Matteo Kenji Miazzo, Chicago, IL (US); Scott Frederick Majkowski, Chicago, IL (US)

(21) Appl. No.: 17/967,784

(22) Filed: Oct. 17, 2022

Related U.S. Application Data
(60) Provisional application No. 63/257,917, filed on Oct. 20, 2021.

(51) Int. Cl. G06Q 30/02; G06N 3/08

(52) U.S. Cl. CPC G06Q 30/0201; G06N 3/08; G06Q 50/01

(57) ABSTRACT

A sponsorship exposure metric system and a method for determining sponsorship exposure metrics are provided. An example system includes a processor configured to analyze a source media based on predetermined parameters. The source media may include a sponsor message. The processor is further configured to determine, based on the analysis, sponsorship exposure metrics associated with the sponsor message. The sponsorship exposure metrics may include at least one of the following: a brand exposure, an asset exposure, a scene type exposure, an active exposure, and a passive exposure. The processor is further configured to provide the sponsorship exposure metrics to a sponsor associated with the sponsor message.

### CROSS-REFERENCE TO RELATED APPLICATIONS

The present U.S. Non-Provisional Patent Application claims the priority benefit of U.S. Provisional Patent Application Ser. No. 63/257,917 filed on Oct. 20, 2021, and titled “Sponsorship Exposure Metric System,” which is hereby incorporated by reference in its entirety.

### TECHNICAL FIELD

The present disclosure relates generally to data processing and, more particularly, to systems and methods for determining sponsorship exposure metrics.

### BACKGROUND

Sponsorship exposure is usually measured as a period of time during which spectators receive exposure to a sponsor message. The spectators may receive exposure during a live sponsored event or in mass or social media after the sponsored event. Sponsorship-based marketing is an efficient way for marketers to draw attention of spectators to sponsor messages provided by marketers during sponsored events. However, conventional sponsorship-based marketing systems usually determine the sponsorship exposure based on the period of time a sponsor message is shown in the media and number of viewers, but do not consider other factors that may affect the sponsorship exposure, such as, a location, size, or blurriness of the sponsor message, and so forth.

Moreover, even though some conventional sponsorship-based marketing systems can use neural networks for determining the sponsorship exposure, those neural networks are only used for classification or object detection.

Existing systems for brand and asset detection run the detection in brand and asset independently of each other. For example, a conventional system typically runs a detection for brands, then separately runs detection for assets, and eventually combines the two independent results.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an example embodiment, a sponsorship exposure metric system is provided. The system may include a processor and a memory communicatively coupled to the processor. The processor may be configured to analyze a source media having a sponsor message based on predetermined parameters. The source media may include an image, a video, a digital media, a social media, and so forth. The source media may be broadcast on TV, posted in social media, or provided in any other way to viewers. The analysis may be performed using at least one of a default model, a model shared between different sports, and a dedicated model for a source. The analysis may include an optical character recognition (OCR)-based classification of the source media, a classification based on description of the source media, a machine learning based classification, and other types of analysis.

Based on the analysis, the processor may determine sponsorship exposure metrics associated with the sponsor message. The sponsorship exposure metrics may include one or more one of the following: a brand exposure, an asset exposure, a scene type exposure, an active exposure, a passive exposure, and so forth. The processor may then provide the sponsorship exposure metrics at least to a sponsor of the sponsor message.

In some exemplary embodiments, an intelligent secure networked messaging system configured by at least one processor to execute instructions stored in memory, the system comprising, a data retention system and an analytics system, the analytics system performing asynchronous processing with a computing device and the analytics system communicatively coupled to a deep neural network. The deep neural network is configured to receive a first input at an input layer, process the first input by one or more hidden layers, generate a first output, transmit the first output to an output layer and map the first output to a sponsor. In some exemplary embodiments, the sponsor name may be an outcome.

In further exemplary embodiments, the first outcome is transmitted to the input layer, processed by the one or more hidden layers, generates a second output, transmits the second output to the output layer, provides the second output to the sponsor, and the second output generates a second outcome from the sponsor.

The outcome from previous embodiments is then transmitted to the input layer of the directly connected one or more embodiments as input.

In various exemplary embodiments, the first input is a source media, the source media may include an image, a video, a text, and/or a sponsor message and the sponsor message may include a brand name. The sponsor message may also include a logo, and/or a slogan. The first outcome from the sponsor may include such things as an amount of sales generated by the first output.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 is a schematic diagram showing sponsorship exposure metrics that can be determined by a sponsorship exposure metrics system of the present disclosure, according to an example embodiment.

FIG. 2 is a block diagram showing steps performed in a method for determining sponsorship exposure metrics, according to an example embodiment.

FIG. 3 is a block diagram showing sponsorship exposure metrics determined by a sponsorship exposure metrics system, according to an example embodiment.

FIGS. 4A and 4B show an input image in two resolutions, according to an example embodiment.

FIG. 5 shows an input image with occlusion, according to an example embodiment.

FIG. 6 shows a frame of motion blurred in video, according to an example embodiment.

FIG. 7 shows an image output of brand detection, according to an example embodiment.

FIG. 8 shows a video output of brand detection, according to an example embodiment.

FIG. 9 shows an architecture of a brand module of the system, according to an example embodiment.

FIG. 10 shows logo variations in size and blurriness, according to an example embodiment.

FIG. 11 shows an entity-specific brand spotter, according to an example embodiment.

FIG. 12 shows an example of an entity-specific brand list for an entity-specific spotter, according to an example embodiment.

FIG. 13 shows fusion/merging of results in an image, according to an example embodiment.

FIG. 14 shows asset detection results in an image, according to an example embodiment.

FIG. 15 shows an architecture of an asset module, according to an example embodiment.

FIG. 16 shows the architecture of the semantic object of interest (SOI) detection part, according to an example embodiment.

FIG. 17 shows SOIs spotted under a hockey model, according to an example embodiment.

FIG. 18 shows a sample image classified as a goal celebration, according to an example embodiment.

FIG. 19 shows an architecture of a scene module, according to an example embodiment.

FIG. 20 shows action classification on basketball (left) and soccer (right) game, according to an example embodiment.

FIG. 21 shows Stats Leader custom label classification for Euroleague, according to an example embodiment.

FIG. 22A shows pre-game warmup classification, according to an example embodiment.

FIG. 22B shows training classification, according to an example embodiment.

FIG. 22C shows action classification, according to an example embodiment.

FIG. 23A shows keywords for the scene “Goal Graphic”, according to an example embodiment.

FIG. 23B shows a video frame classified as “Goal Graphic” based on keywords, according to an example embodiment.

FIG. 24 shows an example description of a post, according to an example embodiment.

FIG. 25 shows an example of a birthday post classified based on description, according to an example embodiment.

FIG. 26 shows active detection in an image, according to an example embodiment.

FIG. 27 shows passive detection in an image, according to an example embodiment.

FIG. 28 is a schematic diagram showing a structure of a neural network used by an active/passive detection module, according to an example embodiment.

FIG. 29 is a schematic diagram showing a base image model, according to an example embodiment.

FIG. 30 is a schematic diagram showing a base meta model, according to an example embodiment.

FIG. 31 is a schematic diagram showing a merged model, according to an example embodiment.

FIG. 32 shows a computing system that can be used to implement a system and a method for providing sponsorship exposure metric, according to an example embodiment.

FIG. 33 shows an exemplary deep neural network.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides a sponsorship exposure metric system (also referred to herein as a system) and a method for determining sponsorship exposure metrics. The system and the methods described herein can provide marketers/sponsors/clients with the most accurate and real-time view of where and how their sponsorship exposures occur across different media (digital, social, etc.).

The system uses multiple layers, detection types, and algorithms that work symbiotically to represent a true and real-time picture of where sponsorships are displayed based on brand, asset, scene, and active or passive exposure detection. The sponsorships may be displayed in the form of a sponsor message providing some text, image, or video, such as a brand name (also referred to herein as a brand), a logo, a slogan, a hashtag, a tagged mentioning (e.g., @text), a text mentioning, a sports type, a league name, a team name, a social media comment, a social media description, and so forth. In other words, the sponsor message may include one or any combination of the following: a brand name, a logo, a slogan, a text, a hashtag, a tagged mentioning, a text mentioning, a sports type, a league name, a team name, a social media comment, a social media description, and the like.

The system can analyze a source media having a sponsor message based on predetermined parameters. The source media may include a digital media item or a social media item, which can be received via a media stream, social media, broadcast media, received from a video source such as an over-the-top (OTT) media service, TV, and so forth. The source media may include an image, a video, a text, a joint text description, and combinations thereof. The source media may be broadcast on TV, posted in social media, or provided in any other way to viewers. The system performs identifying brand names or sponsor names in any given media type, including images and the videos. For each spotted brand name or sponsor name, the system reports a location as well as provides additional enriched metrics related to the location. For example, the system may spot the brand logo “Nike®” on a jersey of a sports player. The system may determine not only the location of the brand logo, but also the size of the brand logo, the blurriness of the brand logo, whether the brand logo is spotted on a jersey, in the press conference board in the backend, an advertisement board, and a plurality of other metrics.

The predetermined parameters may include, for example, rules for selecting a specific model for an analysis of a particular source media. The predetermined parameters may further include rules for selecting a specific scene classification for an analysis of a particular source media. The analysis may be performed using at least one of a default model, a shared model, and an entity-specific model (such as a sport-specific model), which are described in more detail below. An individual sport-specific model may be used for different sport types, such as soccer, hockey, basketball, and so forth. The analysis may include an optical character recognition (OCR)-based scene classification of the source media, a description-based scene classification, a machine learning based scene classification, and other types of analysis.

In an example embodiment, the analysis may be based on a generic brand detection model, a shared brand detection model, an entity specific brand detection model, or any combination of thereof. In a further example embodiment, the analysis can be based on at least two or more of the following: a generic asset detection model, a shared asset detection model, and other asset detection models, such as sports-specific asset detection models. In a further example embodiment, the analysis may be based on a generic active passive detection model.

Based on the analysis, the system may determine sponsorship exposure metrics associated with the sponsor message. The sponsorship exposure metrics may include one or more one of the following: a brand exposure, an asset exposure, a scene type exposure, a motion estimate (in video), an active exposure, a passive exposure, and so forth. The system may then provide the sponsorship exposure metrics to a sponsor of the sponsor message. The sponsorship exposure metrics can be also provided to any consumer of the data for research, insights, reporting purposes, and so forth.

The sponsorship exposure metrics system can use its own pre-defined syntax, assets, active/passive tags, and a list of tags different from the industry standards or the ones that are conventionally used in the industry. Moreover, the sponsorship exposure metrics system not only receives images and videos as the raw inputs, but also takes additional inputs such as a source entity. Furthermore, the sponsorship exposure metrics system not only uses a single neural network, but a neural network assembled from multiple networks, each of which is trained and used for a particular purpose (e.g., a different sport type).

In contrast to conventional systems that provide limited types of metrics, the sponsorship exposure metrics system of the present disclosure provides exposure measurements in brand, asset, scene, and active passive/exposure. The sponsorship exposure metrics provided by the system include a location, duration, screenshare, blurriness, scene type, asset type, and active/passive exposure type. Moreover, the system runs the exposure detection jointly, while the conventional systems on the market deploy independent systems for detection of different types of metrics. Furthermore, the system defines its own set of input and output customized asset types, and customer oriented scene type.

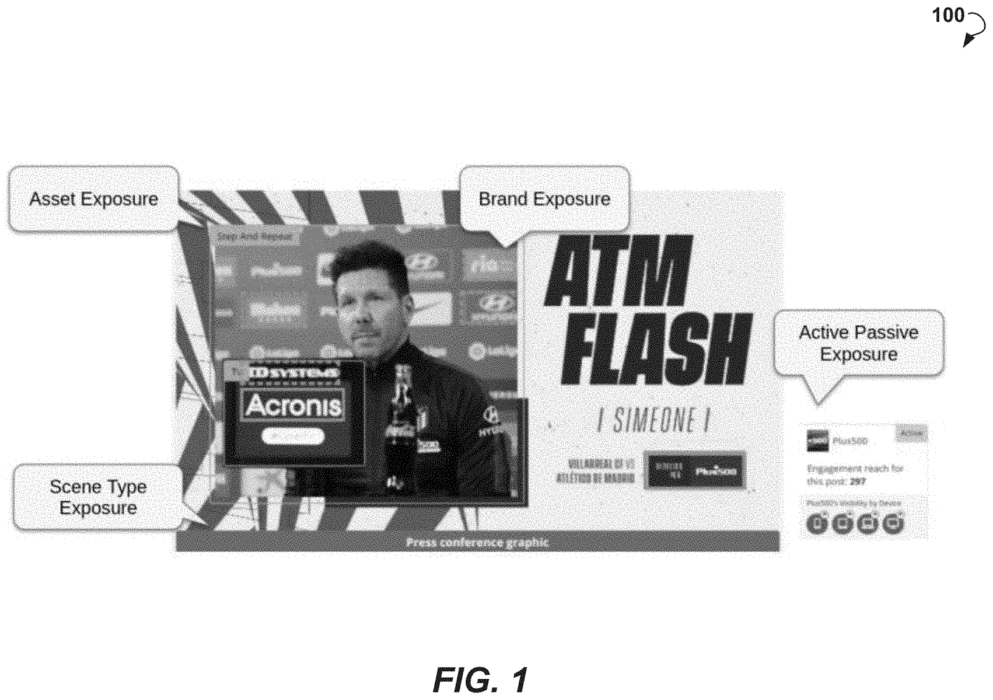

FIG. 1 is a schematic diagram 100 showing sponsorship exposure metrics (also referred herein to as metrics) that can be determined by the system of the present disclosure. As shown in FIG. 1, there are multiple different exposure types determined by the system. The exposure types include a brand exposure (e.g., a sponsor name, such as “Acronis®”), an asset exposure (e.g., the placement of a brand name, such as “Acronis®” on a TV screen), a scene exposure (including a categorical name of an image (e.g., a press conference shown in FIG. 1) and indications where an image or video was taken, and an active/passive exposure. The active/passive exposure metrics enables informing the sponsor whether a brand name is actively inserted into the image by a human, or shown passively in the background of the image.

In the example shown in FIG. 1, “Plus500” brand information is added (overlaid) to the image by a media provider before posting to the social media. In FIG. 1, the “Plus500” brand information relates to the active detection because this information was added to the image before posting, and brand names (Acronis®, Mahal Beer®, Ria money transfer®, and Hyundai®) on a photo of a person relate to the passive detection. FIG. 1 is an example schematic diagram in the form of a press conference graphics showing sponsorship exposure metrics that can be provided to the sponsor. The sponsorship exposure metrics can be framed, highlighted, colored, or otherwise indicated on the schematic diagram provided to the sponsor.

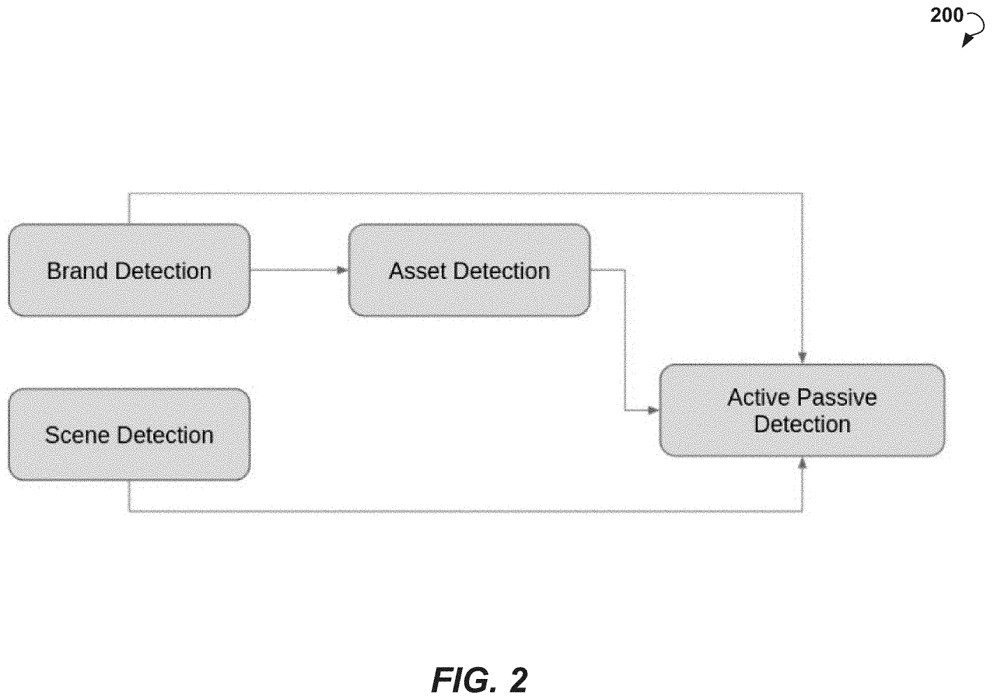

FIG. 2 is a block diagram 200 showing steps performed by a method for determining sponsorship exposure metrics using four individual detectors, according to an example embodiment. The detectors include brand detection, scene detection, asset detection, and active/passive detection. Each of the detectors has separate machine learning algorithms that have been trained for finding relevant data, such as brand names, logos, slogans, and so forth. The system may first perform a brand detection and a scene detection. After performing the brand detection, the system may proceed to asset detection. Upon performing the brand detection, the scene detection, and the asset detection, the system may proceed to active/passive detection.

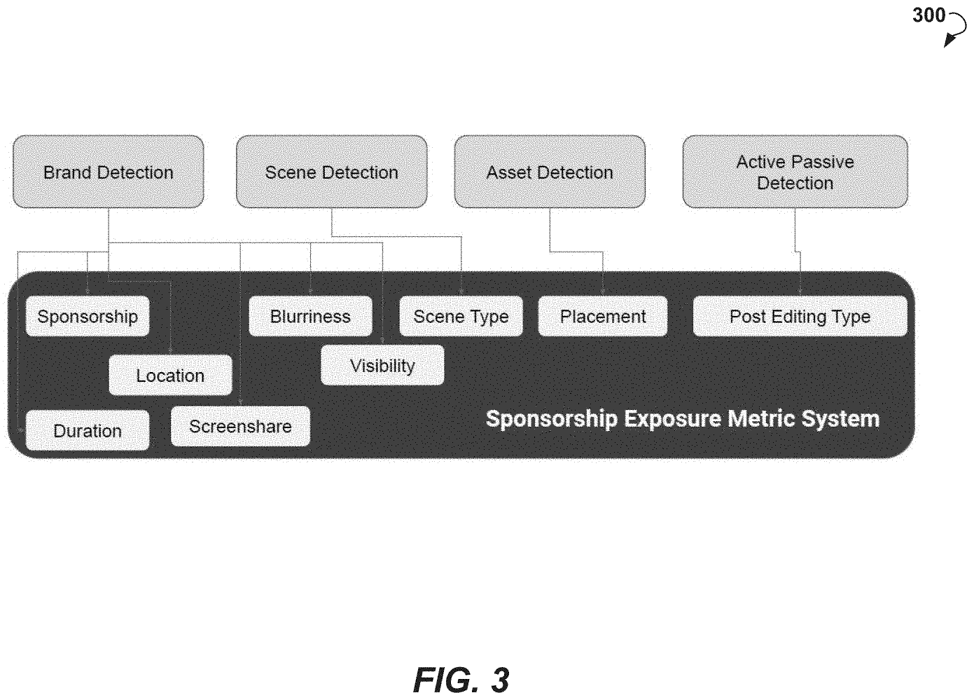

FIG. 3 is a block diagram 300 showing sponsorship exposure metrics determined by the system, according to an example embodiment. The sponsorship exposure metrics may include, without limitation, a sponsorship, a location, duration, a screenshare, blurriness, visibility, scene type, placement, a post editing type.

The brand detection layer identifies the sponsor exposure in both images and videos. This layer measures the sponsorship exposure in locations, size, blurriness, duration in video, and many other aspects. Multiple algorithms are running in parallel to report the brand detection results. The system can perform multi-layer detection for brand spotting results. Additionally, an entity-specific brand logo spotting detection algorithm can be trained for the system. The results from these separate algorithms are then post-processed and merged to provide the most precise and full detection for each brand logo within each image or video frame.

Moreover, the brand detection layer may perform multiple resolution and blurry level generation to mimic the resolution and blurriness variation. The brand detection layer can also use a brand detection and exclusion map to handle the brand detection with appearance overlap, such as Betway®/Bet365®, Sky Sports®/Sky Bet®, and the like. Moreover, to improve the brand detection, the brand detection layer may perform detection of common occurrences of brands.

Brand detection results are fed into the asset detection and into the active/passive detection as part of the input to asset detection and active/passive detection processes performed by the system. Thus, the brand detection, asset detection, and scene detection results can be used by the active passive detection. Multiple output attributes for customized exposure valuation include one or more of the following: a brand identifier (ID), a location, duration, screenshare, blurriness, visibility, and so forth.

The asset detection layer is used for detection of the placement of a particular brand name (e.g., a brand logo “Nike” is spotted on a uniform). The asset detection uses an ensemble of multiple neural networks. The Mask Region Based Convolutional Neural Network (R-CNN) is the neural network in primary use, but other instance-based neural networks can also be used. The neural network can receive input from multiple variables and perform splitting the placement by sports types, assemble multiple neural networks to process the input, and fuse the results from multiple neural networks.

Each of multiple neural networks can be trained and used for a specific purpose. For example, each neural network can be designed for a specific sport type. The specific-purpose neural network considers parameters associated with a specific entity type. For example, components of a soccer field are considered by a soccer-specific neural network, components of a basketball stadium are considered by a basketball-specific neural network, and so forth. Each sport-specific neural network can be essentially modeled based on the types of things that exist in that sport-specific stadium and space. The neural networks can be trained specifically for the entity/domain using as inputs a plurality of specialized metadata that exist in taxonomy predetermined by the system.

Asset detection takes brand detection results as part of an input, together with the source image or video frame and an additional input (for instance, a source entity ID such as a soccer league), feds all inputs into a neural network that is specifically trained for the soccer field, and outputs different placement types, such as a name of an object on which the input brand name is placed. This combination of the brand name and the object on which the brand name is present is referred to as an asset.

Asset detection can classify generic assets and entity-specific assets (e.g., sport-specific scenes). Asset detection can also classify assets according to the “asset” and “subasset” hierarchy. Asset detection is categorized into distinct sports types. The asset detection in each sports type targets and features unique asset labels. The asset detection layer can utilize customized asset tags based on a specific sports model. The supported sports type in asset detection include soccer, basketball, hockey, and a shared model. Images and videos are processed by different sport models depending on the publishing entity and the results are merged with brand data to determine the object on which the brand name is placed.

Asset detection can use sport specific asset models. Each stadium can be mapped and assets for training defined. In an example embodiment, new assets such as “Seating Tarp” may appear due to the restrictions on in-stadium attendance. The asset detection layer can be configured to define and develop detection and classification for these assets.

The scene detection layer is a classification system which applies one label to the input image or video. A plurality of different scene scenarios (e.g., a press conference, a training, a warm up, a celebration after the goal, etc.) can be pre-defined in the system. The input image and an entity name is provided in combination to the scene detection layer to provide accurate results. Scene detection is not only working on the image and the video frame, but also based on the description (text, icons, emoji) of the posts that were pulled from the source media. Scene detection can classify generic scenes, entity-specific scenes and sport based scenes. Scene detection may use an entity-specific scene classification, a generic scene classification and sport scene classification.

Scene detection uses neural networks and a set of heuristic algorithms to classify a given image or video into a custom set of labels defined in the system. In scene detection, the neural network takes input from the image/video frame, publisher ID, and so forth.

Scene detection works on generic scene labels, which can be pre-defined by the system. Scene detection also cooperates with a set of entity specific scene labels, which targets a single sports team or league, on demand. Scene detection also cooperates with a set of sport specific scene labels, which targets a single sport, on demand.

The active/passive detection layer can be fully trained to differentiate the logos that were digitally inserted into a frame from logos that were captured in the original recording of the image or video. This layer accepts results from brand, scene, asset detection results as well as data from the original post as inputs into the resulting classification. The active/passive detection layer may have a meta feature (for example, a sports team) and a media feature (for example, an image).

The initial component of the system is built to spot brands in digital and social media. This component is referred to as a brand module in the present disclosure. The input of the brand module are images or videos. Images come in a large variety of resolutions. Variations in appearance and resolution of images directly affect the detection results made by the brand module.

All classification layers can work automatically in tandem with each other to improve detection and categorization automation and accuracy.

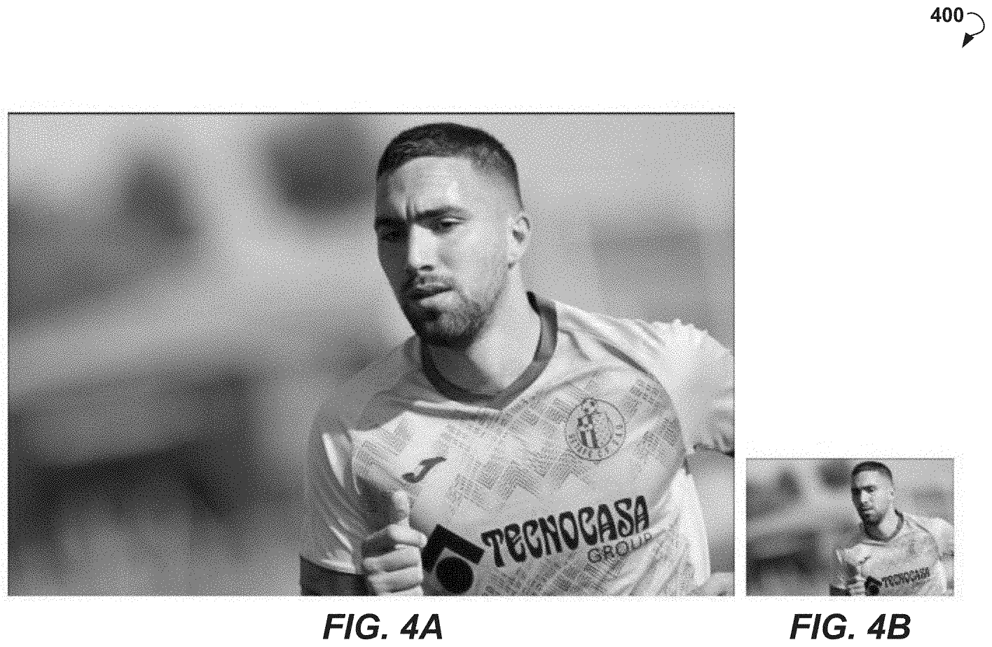

One example of resolution variations in shown in FIGS. 4A and 4B. FIGS. 4A and 4B show a sample input image in two resolutions, according to an example embodiment. The ratio of resolution between the image of FIG. 4A and the image of FIG. 4B is 16:1. While the brand logo ‘Joma’ in the image in FIG. 4A is clearly perceivable by the human eye, the same brand logo in the image in FIG. 4B is not perceivable.

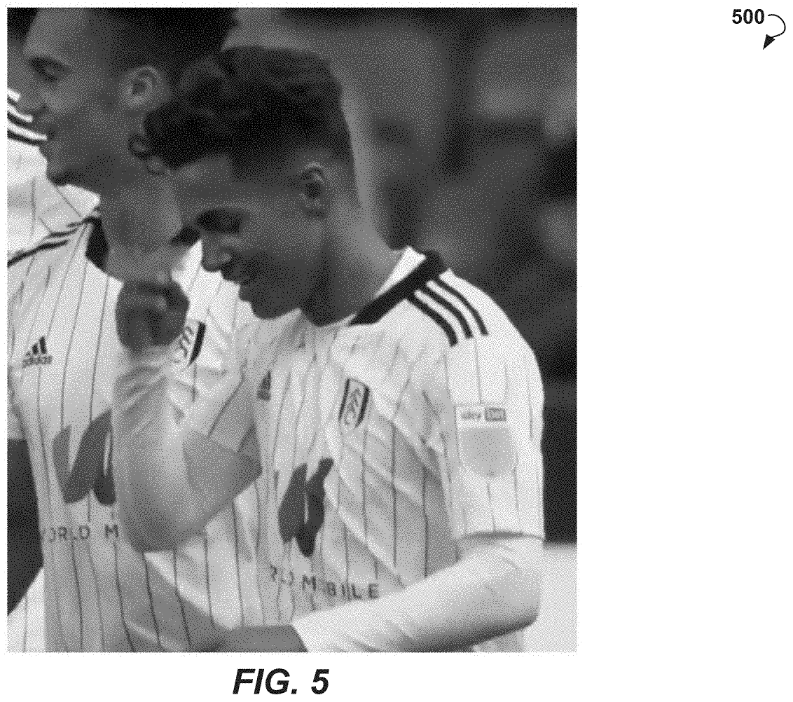

One other common case of input image variation in the brand module is occlusion. FIG. 5 shows an input image with occlusion, according to an example embodiment. There are two types of occlusion depicted in the input image. One is the occlusion caused by another object. The brand name ‘World Mobile’ on the rear player's jersey is occluded by the player in the front. The other type of the occlusion is self-occlusion. The brand name ‘World Mobile’ on the front player's jersey is half visible due to the angle of the image.

In a production environment of the system, the brand module can work to conquer the above-listed challenges and many other challenges arising due to various illumination conditions, capture devices, and so forth.

Processing of a video input is a more complicated process performed by the brand module compared to image processing. On top of all the mentioned challenges, video processing addresses motion blur. By playing the video frame by frame, the subject in the video is blurry due to video capturing speed being lower than the movement of the subject. This is a common issue in any video with a standard frame rate.

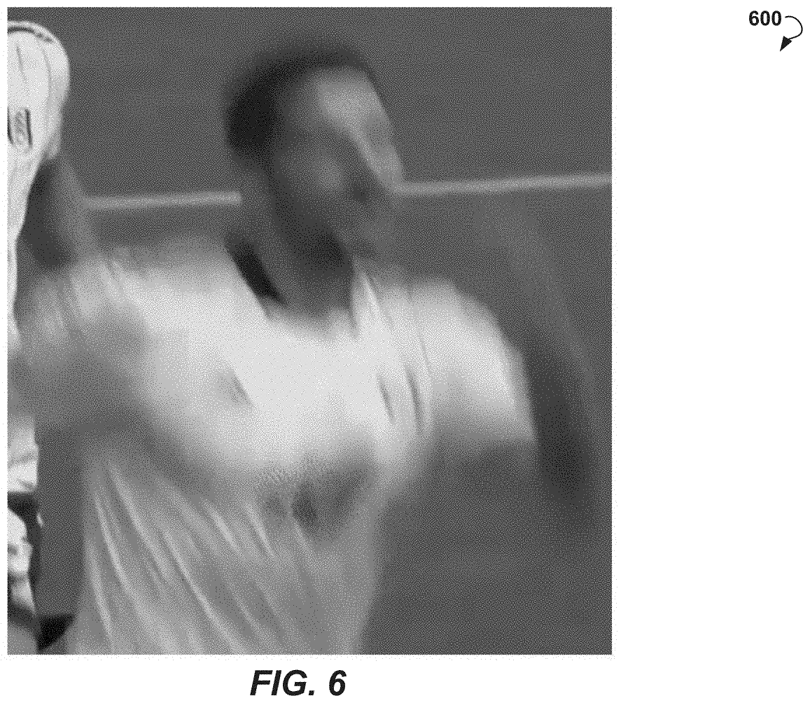

FIG. 6 shows a sample frame of motion blur in video. FIG. 6 shows a single frame from a video. There are two brands present in the video frame, one brand is Adidas®, and the other brand is World Mobile®. As can be seen in FIG. 6, it is hard to distinguish the brands on the raw video frame with bare eyes.

The output provided by the brand module includes an image output and a video output. The image output may include a sponsor (brand) name, a location (coordinates) of the brand name, a size of the brand name, the blurriness level of the brand name, and the like.

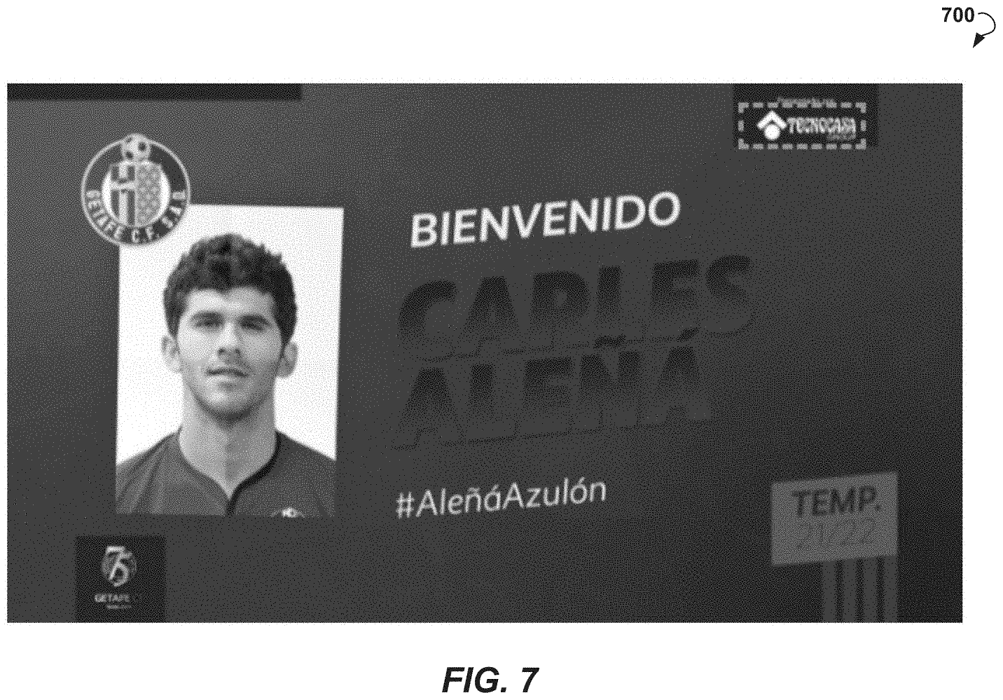

FIG. 7 shows the image output of brand detection, according to an example embodiment. The green box in the image indicates the location and size of the brand name in the image. In addition, the brand module also reports the brand name of the spotting, together with a float value to denote the blurriness level of the spotting.

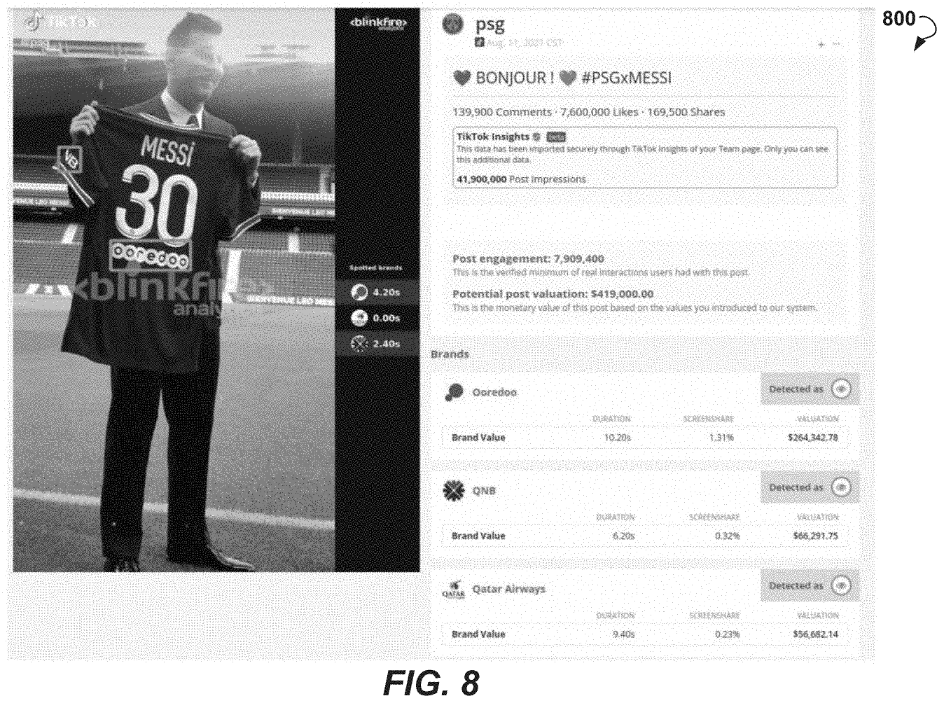

FIG. 8 shows the video output of brand detection, according to an example embodiment. The video output may include a brand (sponsor) name, a location (coordinates) of the brand name, a brand name duration meaning the total number in seconds a brand name is presented in the video, a brand screenshare denoting the average size of a given brand detected in the input video, normalized by the video resolution, and brand duration fractions meaning lists of flow values to indicate the percentage of brand name present in each segment of a video.

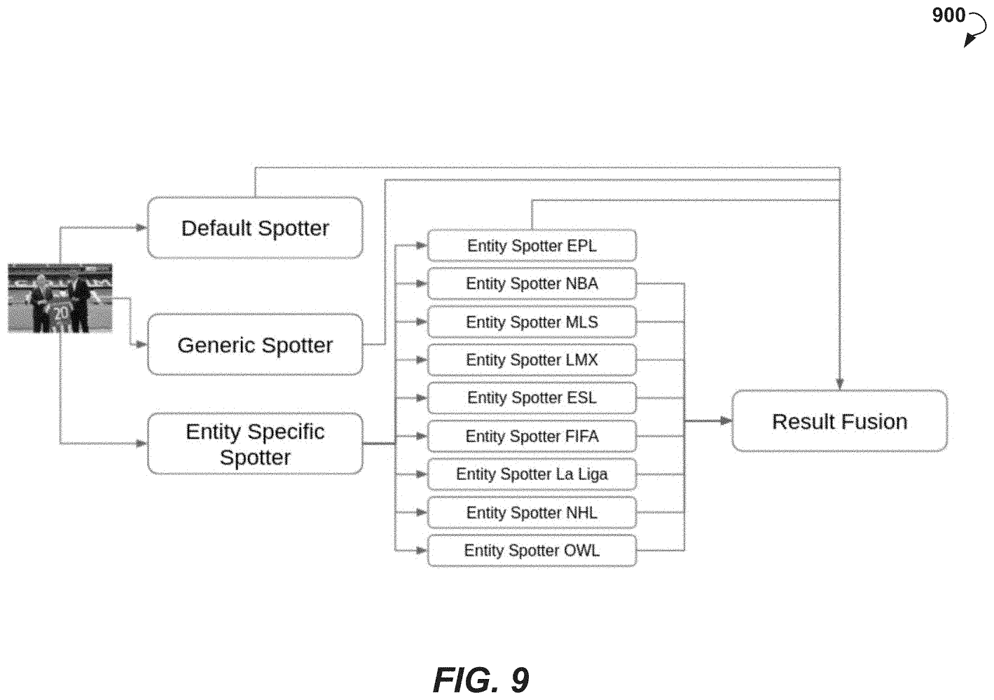

The brand module of the system may include multiple submodules. FIG. 9 shows the architecture of the brand module of the system, according to an example embodiment. The brand module may include multiple spotting submodules, also referred to herein as spotters. The input image or input video may be fed into the multiple groups of spotters of the brand module. The spotters include a default spotter, a generic spotter, and an entity-specific spotter.

The default spotter performs detection of the brand names in source images or source videos with multiple variations in size and blurriness. Any changes to the visual appearance of a specific brand are detected most effectively by the default spotter. The spotting of brand names may vary in size and blurriness level, as described below.

The generic spotter covers a wide range of brand names. This layer of brand name detection supplements the default spotter by detecting the most common visual variations of different logos.

The entity specific spotters are a set of spotters designed to detect brand names for a specific entity. Images and videos are selectively processed by the entity spotters depending on the source entity. For example, an image post from the Manchester United F.C. twitter account may be processed by the English Premier League (EPL)-specific spotter. After the image or video is processed by the three categories of spotter, the results are combined together.

As mentioned earlier, two common challenges faced when brand spotting are variations in size and blurriness. In order to overcome the challenges, the brand module applies a brand template synthesis as part of its process.

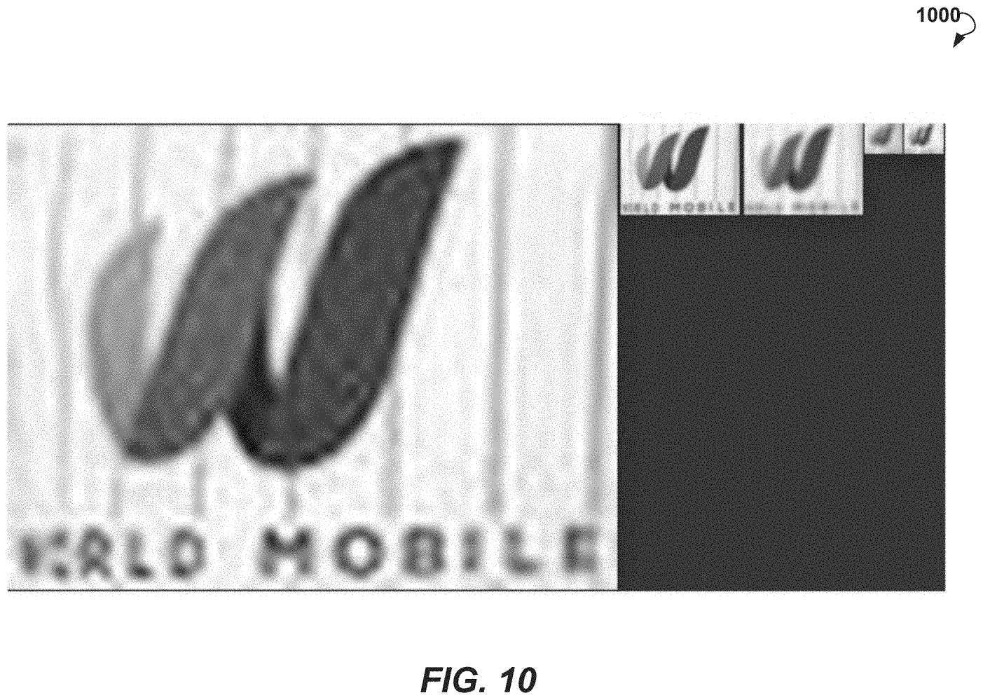

FIG. 10 shows logo variations in size and blurriness, according to an example embodiment. As shown in FIG. 10, the system takes one brand appearance example image as input, and synthesizes multiple variations in sizes and blurriness levels. FIG. 10 shows an example of 3 size variations and 2 blurriness variations. For each brand, the system stores multiple variations in different angles of views of a brand. Each of the brand templates can generate a series of variations, which are used for detection. By generating multiple variations of a given logo, the system can address the detection challenges.

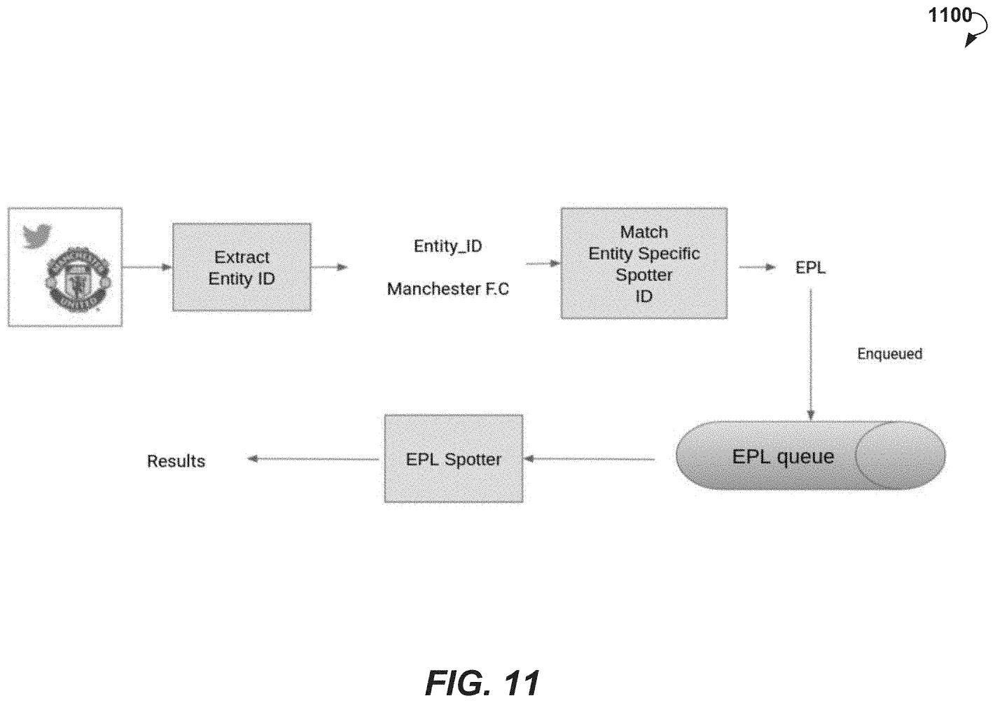

FIG. 11 shows an entity-specific brand spotter, specifically, an EPL spotter. The data flow of the entity specific brand spotter is shown in FIG. 11. In this example, the publishing entity is Manchester United F.C. The entity-specific brand spotter extracts the entity ID from the source item, then determines to which league the team belongs. Using the league ID, the brand module automatically matches the input to the entity-specific brand spotter. In this entity-specific brand spotter, the matched spotter is the EPL spotter.

With the selected spotter ID, the system selects the corresponding task queue to add the task. In the task queue, messages enqueue the Uniform Resource Locator (URL) of the source image and the metadata that is required to uniquely identify the source post.

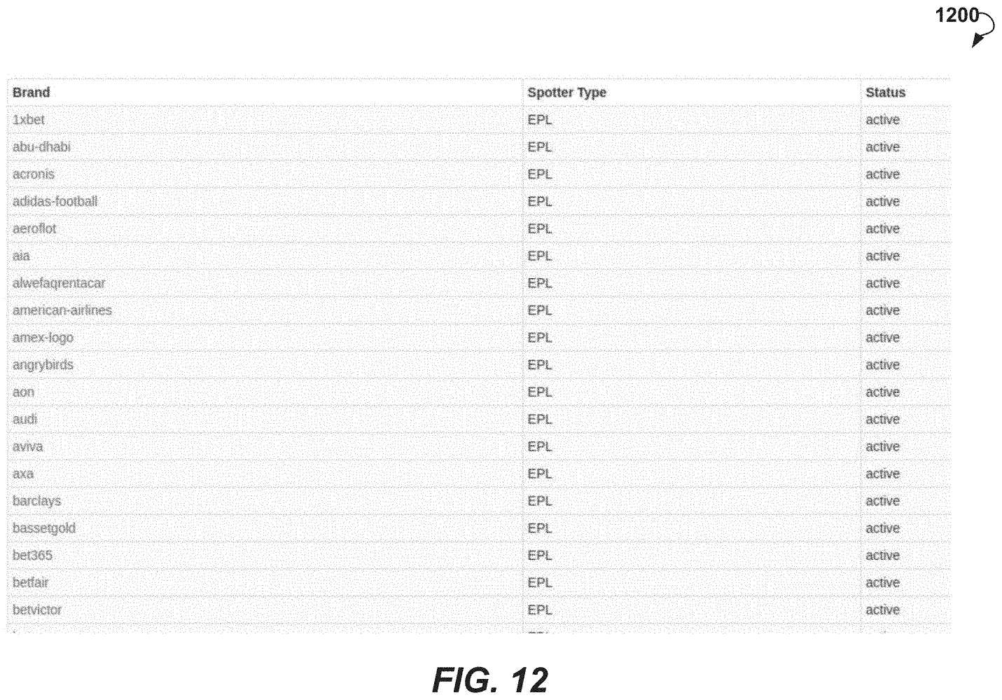

Once the task is dequeued, the EPL spotter starts the spotting process. A list of EPL-specific brands can be detected against the input source image loaded from the image URL. The EPL brand list consists of a list of brands that officially sponsor the EPL, or the teams in the EPL. FIG. 12 shows an example of an entity-specific brand list for the EPL spotter.

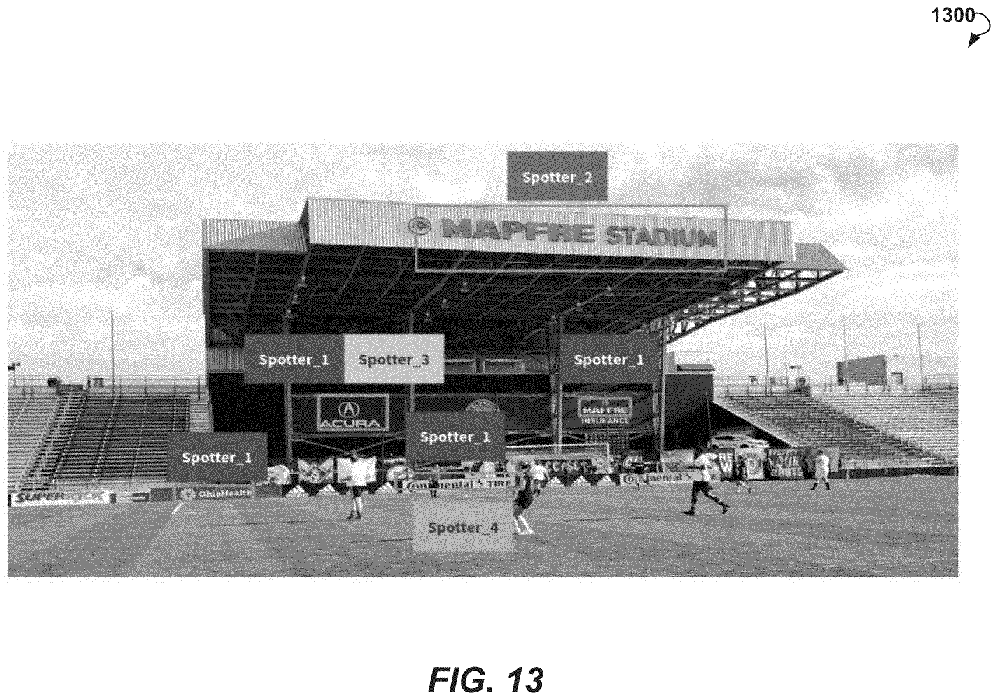

FIG. 13 shows fusion/merging of results in the image. The mapping of the spotter type in the image to the spotters in FIG. 9 are: spotter 1 is the default spotter; spotter 2 and spotter 3 are the generic spotter; spotter 4 is the entity-specific spotter.

FIG. 13 demonstrates that the combination of results from multiple spotters yields better overall results compared to a single spotter. The fusion of the results from multiple spotters is also applied in the video spotting. The video result fusion involves handling of inconsistent video resolution, handling of inconsistent video frame rate, merging metadata from multiple sources into a single copy, re-rendering the video, and regenerating the metrics.

Asset detection. After posts are processed by the brand module, all input media from social network feeds containing brands are then passed to an asset module for asset detection. The asset module performs a two-part process: semantic object of interest (referred to as SOI) detection and brand-SOI correlation (referred to as asset detection).

As an input, the asset module accepts images or videos from posts where a brand name has been detected by the brand module, the location data (coordinates) of the detected brand names, and the sport type to which the post belongs.

The key difference between these inputs for images and videos is the format of the brand data: image brand data contain the sponsor (brand) name and the coordinates of the brand, while video brand data is taken from a JSON file which contains the per-frame coordinates.

The outputs of the asset module can vary depending on the media type of the input. For images, the asset module can return the SOI mask, which is an image that contains the location indexed by the color of detected objects, or SOI mask is a list of polygons to represent the detected objects. The asset module can further return the polygonal coordinate data for each detected SOI. In other embodiments, the asset module can return the SOI-brand combinations present in the image.

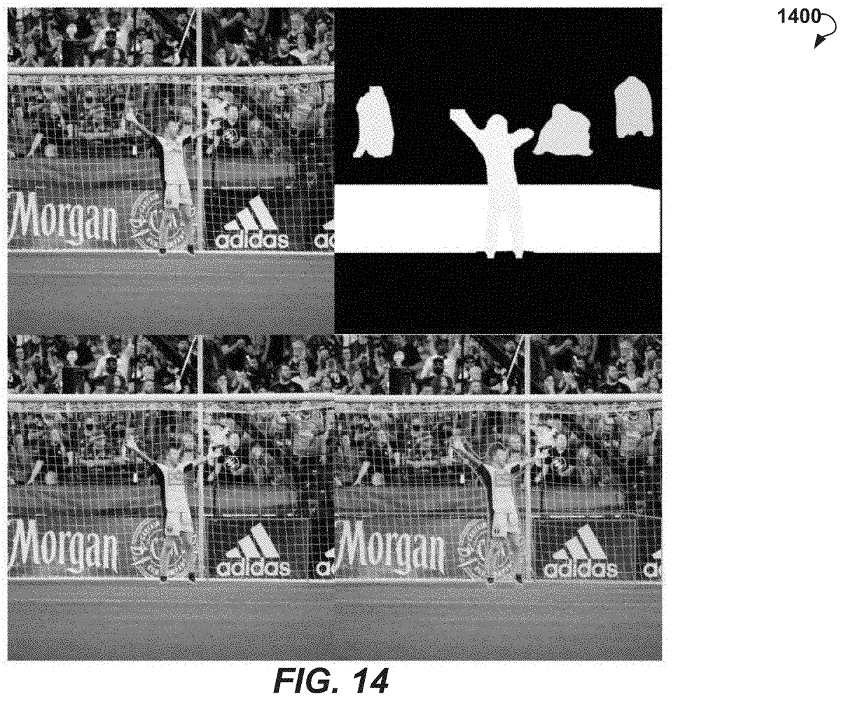

FIG. 14 shows asset detection results in image. The top left image is an example input image. The top right image is the corresponding SOI mask. The bottom left image is detected brands and their locations. The bottom right image is the final detected assets. In this embodiment, the assets are “Adidas®—Adboard” and “Alaska Airlines®—Uniform.”

For videos, the asset module can return the SOI mask video or a JSON file with a set of polygons encoded into polyline strings. Each frame of the mask video corresponds to a frame from the original video. The asset module can further return SOI coordinates, indexed by frame in a JSON file. SOI-brand combinations indexed by frame in a JSON file return SOI-brand combinations indexed by frame in a JSON file.

Similarly to the brand module, the asset module also returns video-specific metrics, such as asset duration, asset screenshare, and asset duration fractions. Asset duration is the total number of seconds a given asset is detected in the input video. Asset screenshare is the average size of the asset spotted in the input video normalized by the video resolutions. Asset duration fractions indicate the asset presence in a given section of video.

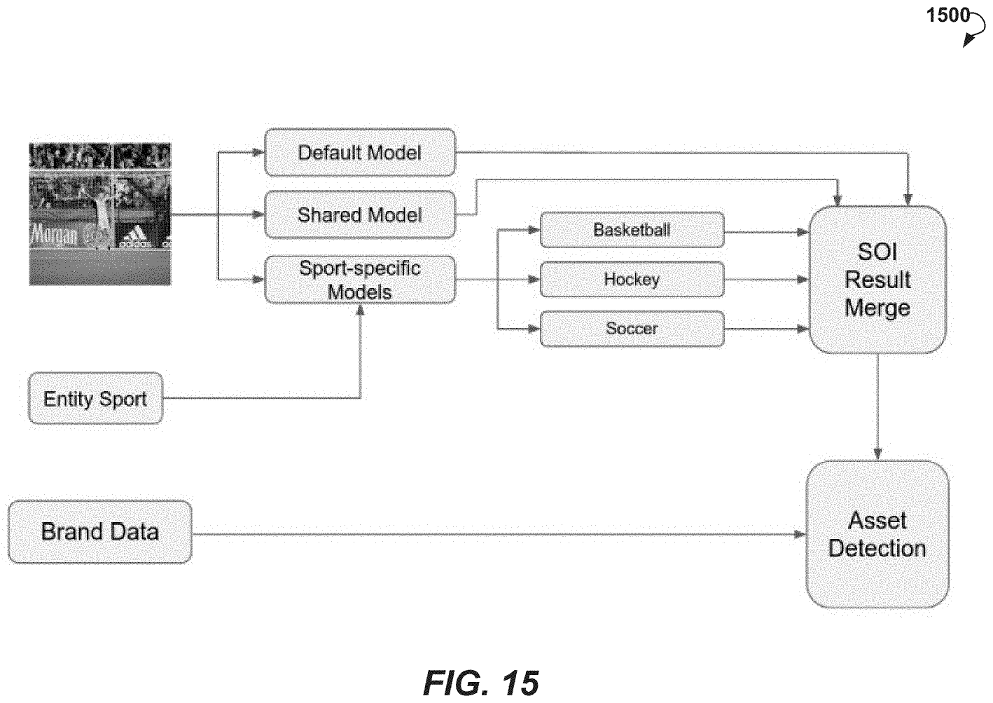

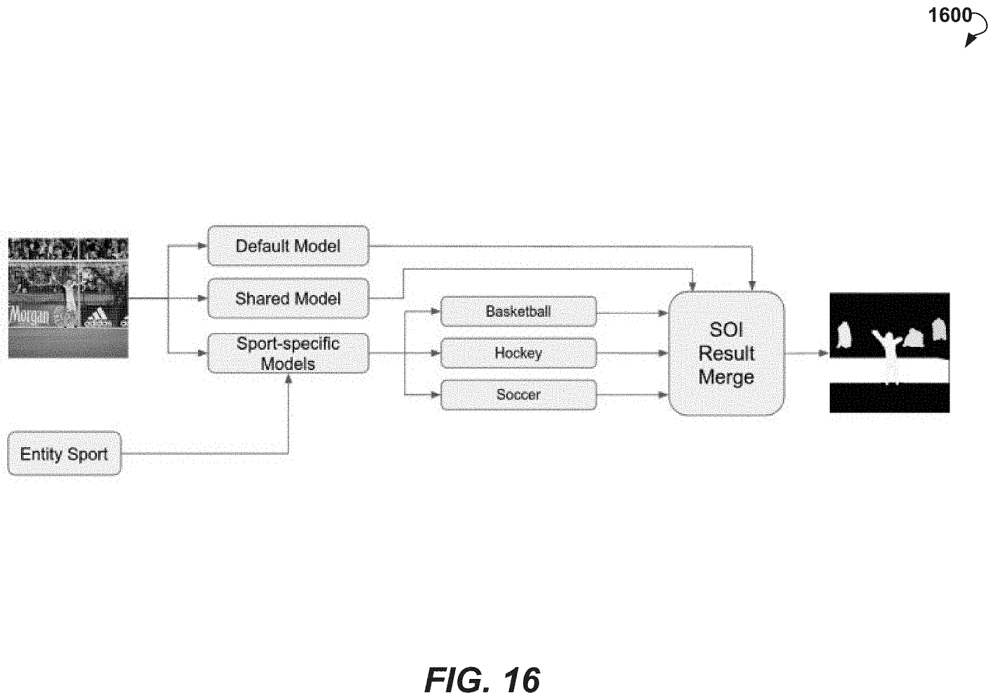

FIG. 15 shows an architecture of the asset module, according to an example embodiment. The asset module contains two parts: SOI detection part and asset detection part. The architecture of the SOI detection part is displayed in FIG. 16. An input image or video can be processed by at least three types of models: a default model, a shared model, and sport-specific models.

The default model consists of a pre-trained model from Mask RCNN. This model can be preliminarily trained on the Common Objects in Context (COCO) dataset and is not modified. Some examples of items which can be spotted by the default model are uniforms, cars, buses, and so forth.

The shared model contains common objects in the sports domain that are defined by the system. This model is trained using annotated data generated and retained by the system. Some examples of objects which can be spotted by the shared model include shoes, caps, helmets, and the like.

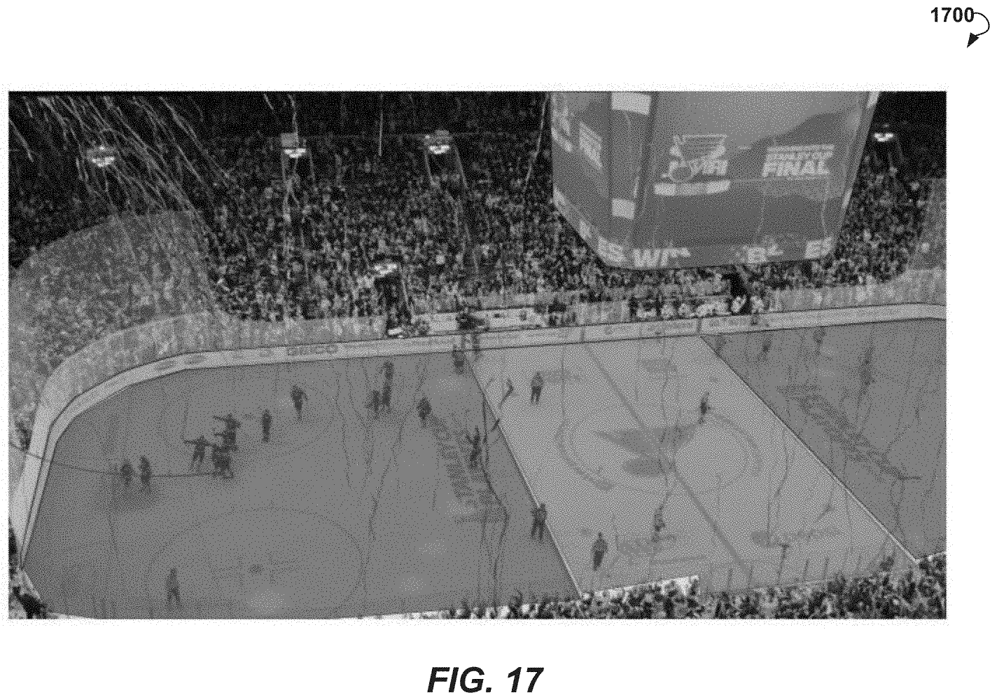

The sport-specific models are a set of models which are trained on items which are specific to a given sport. These models can usually correlate closely with objects which are unique to the sport or are specific to the playing area of the sport. See FIG. 17 showing SOIs currently spotted under the hockey model. Magenta color shows a dasher board, blue color shows an offensive/defensive zone, red color shows a neutral zone, and orange color shows a jumbotron. If a model does not yet exist for a sport, the image or video can only be processed by the default model and the shared model.

In addition to detecting sport-specific assets, siloing sport specific items into specialized models helps to reduce the number of false positives from objects unrelated to a given sport. After processing, the resulting SOI detections from all the models are then sorted in descending size order and overlaid on top of each other to generate the SOI mask.

In asset detection workflow, after the SOI detection, the SOI results and brand data are then combined to generate the final assets. Based on the SOI mask and the brand coordinates, the system can determine any overlap between the spotted brands and the spotted SOIs. If this overlap is greater than a minimum set threshold, the system can generate the brand-SOI combination as an asset.

Scene Detection. The system has a component configured to classify source media to a particular scene category. This component is referred to as a scene module (also referred to a scene classifier). The scene module is dedicated to entity-related or sport-related scenarios and tailored to the customer's needs.

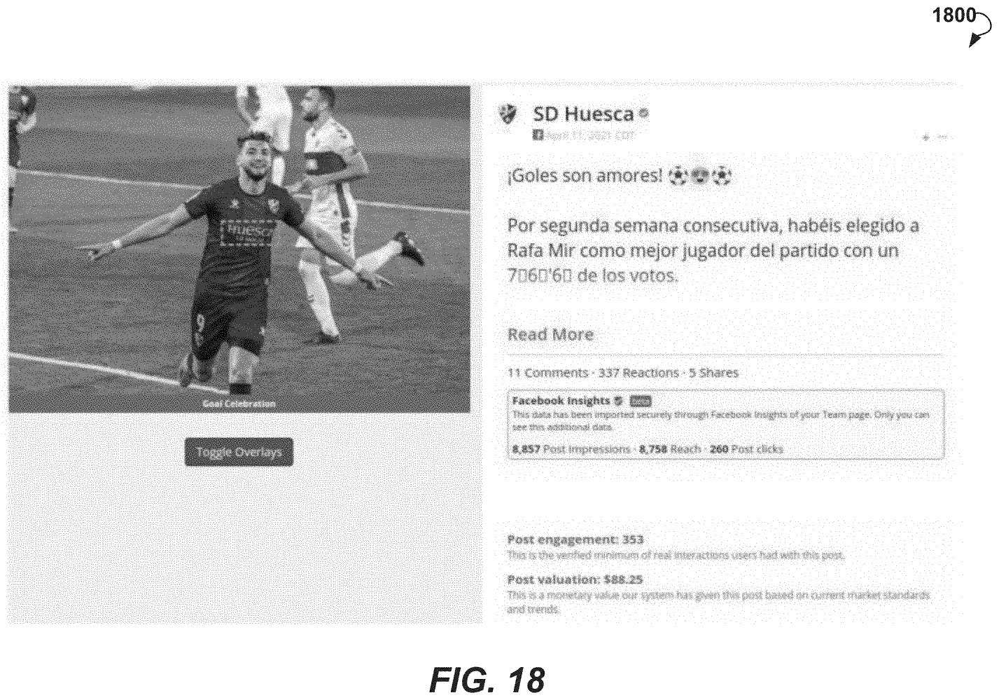

“Goal celebration” is one among the examples of scene labels defined in the system. The goal celebration example denotes any image or video frame where a player is celebrating the victory of scoring a goal. FIG. 18 shows a sample image classified as goal celebration. As can be seen in FIG. 18, the scene module can be able to identify such scenarios and provide the results for each post.

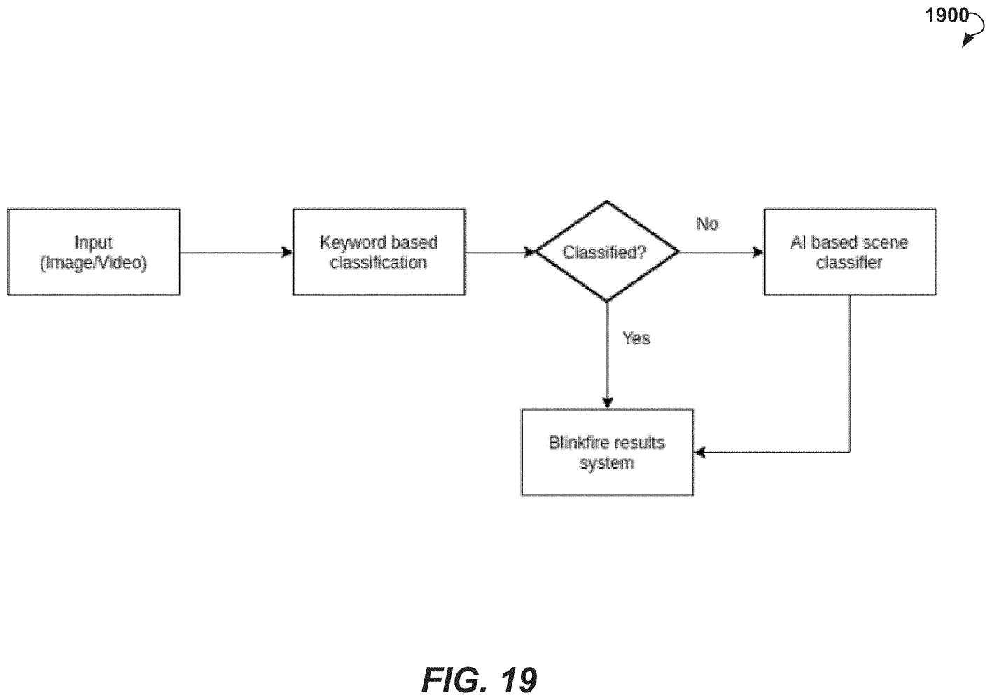

FIG. 19 shows an architecture of the scene module, according to an example embodiment. The scene module can be tailored to meet the customer's requirements on different levels. The scene module may receive an input and perform a keyword-based classification. If the input is classified using the keyword-based classification, the results are stored accordingly. If the input is not classified using the keyword-based classification, an artificial intelligence (e.g., an AI-based scene classifier) is used. The results of classifying by the AI-based scene classifier are then stored as results of the system.

The primary element used by the system is a scene label. The scene label is defined based on the customer's requirements and the content of images/videos posted in social media for a period of time. Scene labels can be classified into the following categories: global scene labels, custom scene labels and sport scene labels.

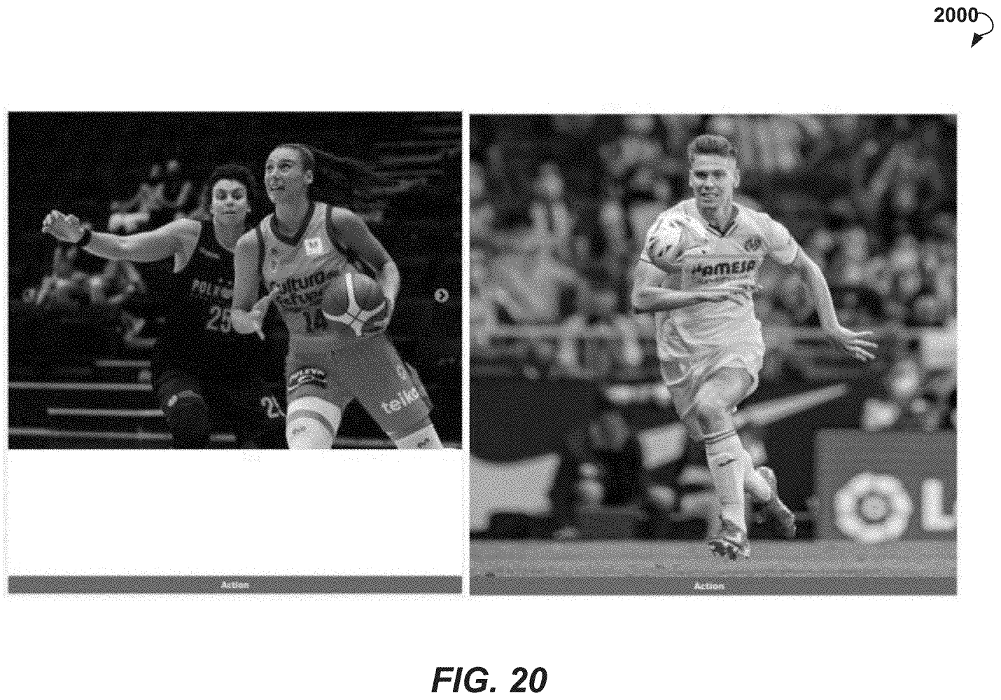

Global scene labels are a set of labels which can be commonly applied across different sport types. For example, there is a scene label “Action” which denotes a scenario where a player is performing an action in the middle of the game. FIG. 20 shows action classification on basketball (left) and soccer (right) game. FIG. 20 explains the label scenario in two different sports. A list of global scene labels may further include training, birthday, game preview, action, locker room interview, in-game headshot.

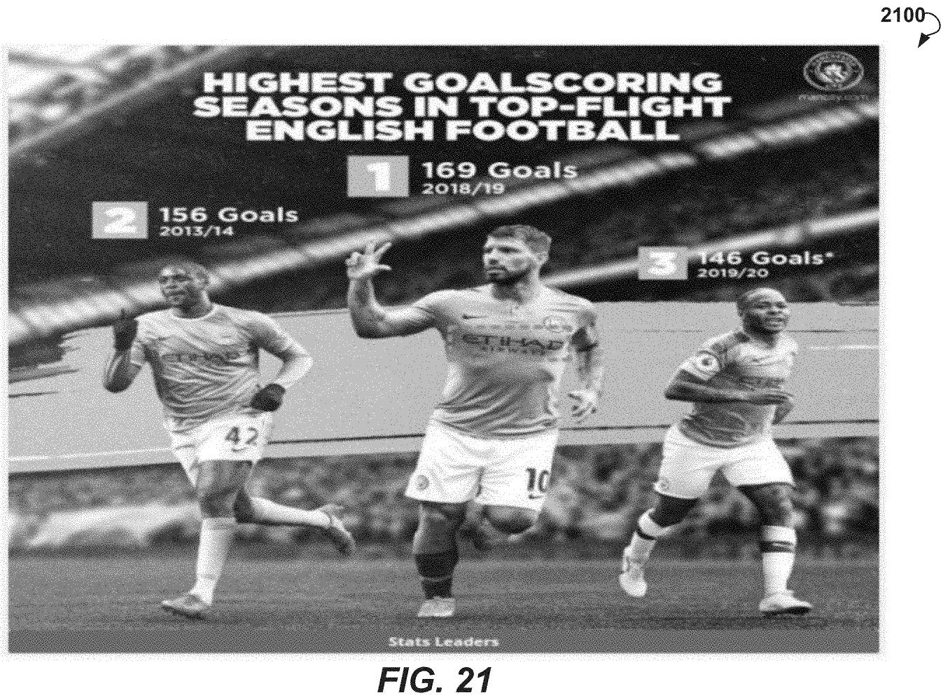

Custom scene labels are a set of labels which are tailored specifically for an entity on demand. Custom scene labels are not applied to any other entity except the one who requested for it. FIG. 21 illustrates this scenario by showing Stats Leader custom label classification for Euroleague. “Stats leaders” is an example customized for “Euroleague” entity media. Similarly, Sport scene labels are a set of labels which are tailored specifically for a sport. These labels are customized for the defined sport and not applicable to other sport categories.

Inputs to the scene module can be either image or video. The images can be of different resolutions and the videos can be of different length. Different types of images have a very subtle difference between each other.

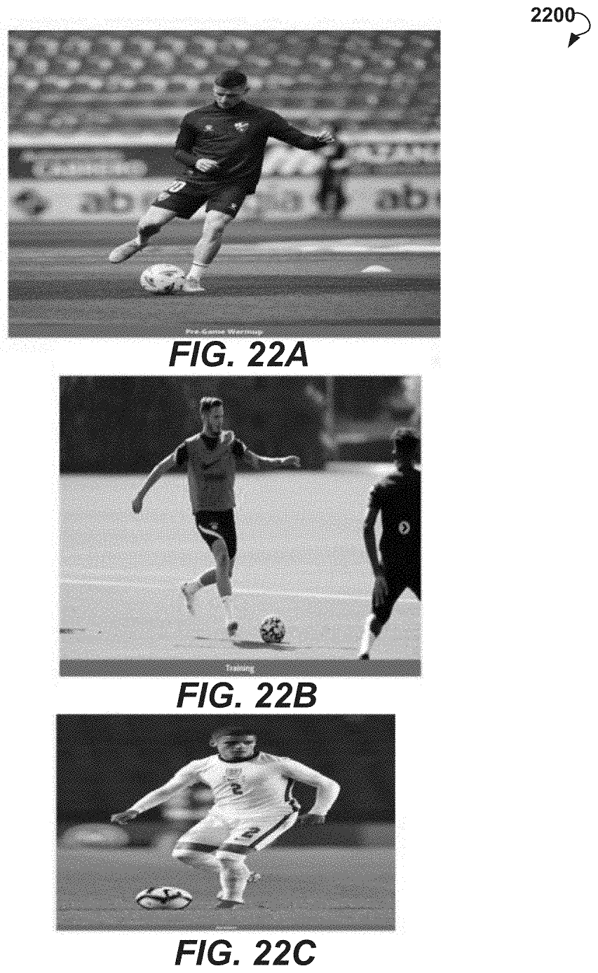

FIG. 22A shows pre-game warmup classification. FIG. 22B shows training classification. FIG. 21C shows action classification. FIG. 22A, FIG. 22B, and FIG. 22C depicts three images which have subtle differences, but the system can classify them correctly in the expected scenarios. All the three images share common components including: a single soccer ball present, a single player captured as the main subject, and all in soccer fields. The key difference in the pictures is the attire of the players. The scene module considers all these cases and provides accurate results.

The keyword-based classification includes classification of text elements, such as descriptions and titles. In addition, there are some visual cues such as a descriptive text graphic as a part of the image. All these elements are provided as inputs into the scene module.

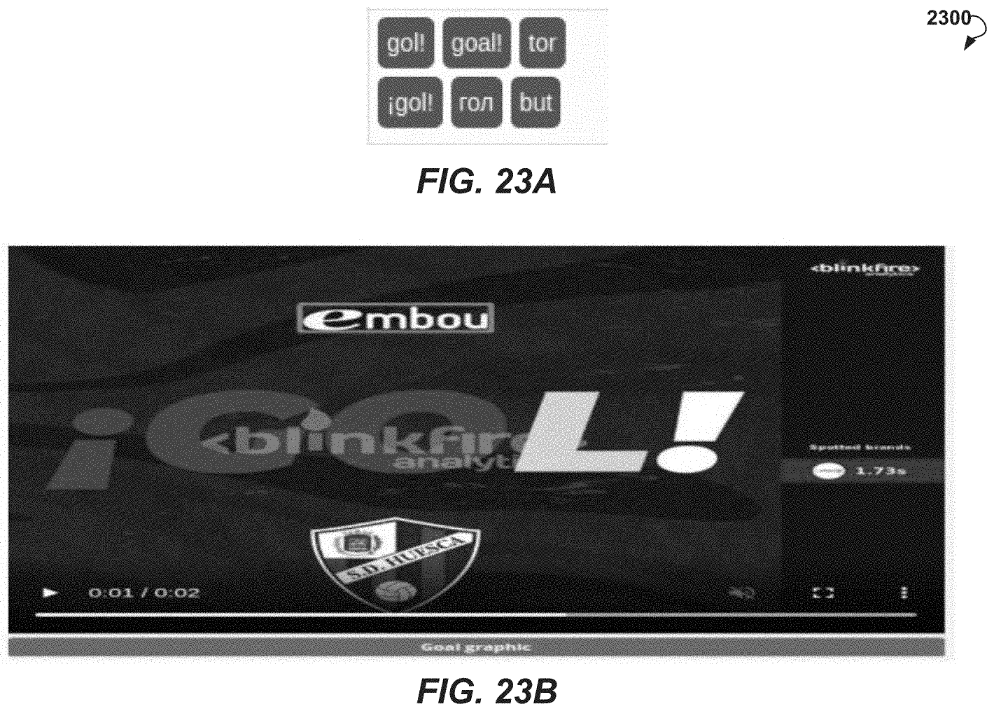

In the OCR-based scene classification, the first sub-category deals with using OCR to recognize the text in the image. The detected text is validated across keyword cues provided by the system for each scene label. For example, there is a scene label “Goal Graphic” which depicts customized graphics that have words like “Goal” or “Gol” or in other languages. The keywords present for this label in the system are represented in FIG. 23A showing keywords for scene “Goal Graphic.”

The system employs an OCR module to detect such keywords in the given image/videos. FIG. 23B represents this example and shows a video frame classified as “Goal Graphic.”

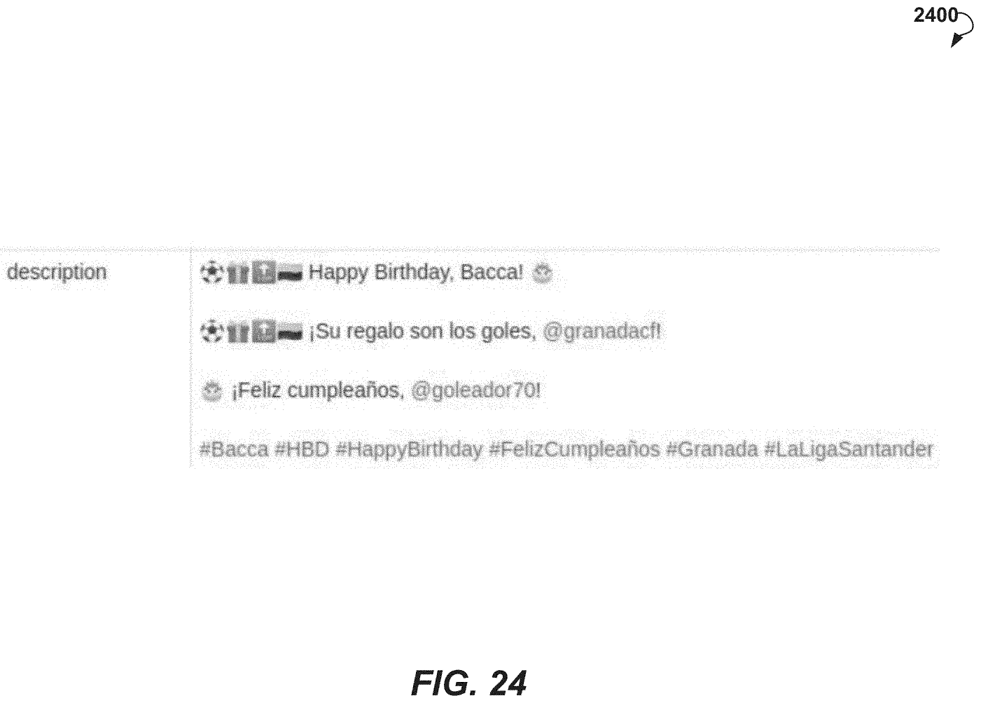

Description-based classification. Based on the above explanation, the second part of the keyword-based classification is to find keyword cues in the description of the posts that need to be classified. Keywords are stored as a part of the scene label, designated for description. For example, there are many birthday posts which have words like “Happy Birthday” in their descriptions. The image does not necessarily denote that it is a birthday image, rather the image can just depict some player and the description explains the reason behind the post. FIG. 24 shows an example description of a post.

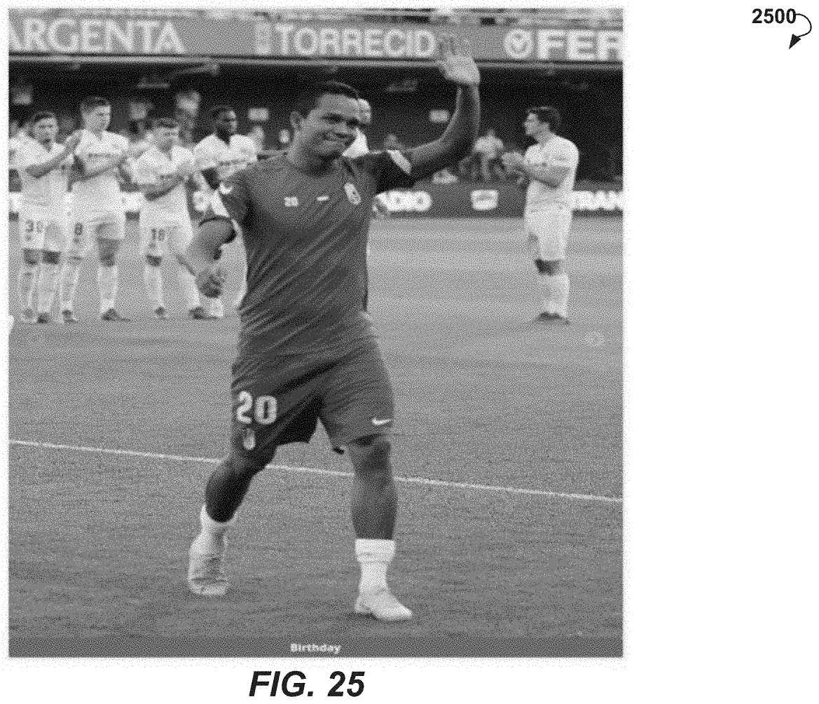

FIG. 25 shows an example of a birthday post and represents the image which was uploaded with the above description. The image itself represents a player waving his hand. According to anyone seeing this picture, this can be classified as “Player congrats” or “Thank you”, but not a birthday. So when performing the description-based classification, the system can attempt to classify such posts correctly as “Birthday.”

AI-based scene classification. As shown in FIG. 19, if there are no detection results from the previous steps, the system moves onto the machine learning based classification. Different machine learning models are used for each media type. Image classification employs ‘InceptionResNetV2’ as a base model, whereas the video classifier uses ‘InceptionInflated3d’ as the base model. Other generic models can be used instead of these base models used in the image and video classification. For image classification, the system takes in multiple inputs: image on which the classification needs to happen and an entity ID, which represents the entity to which the post belongs.

The multiple-input image classification is quite unique in classifying labels without collisions and it delivers results for global/custom/sport scene labels. The models are trained by the system and based on labels to produce the required results. After the classification is done, the results are stored in the system, analyzed, reviewed, and delivered for each post.

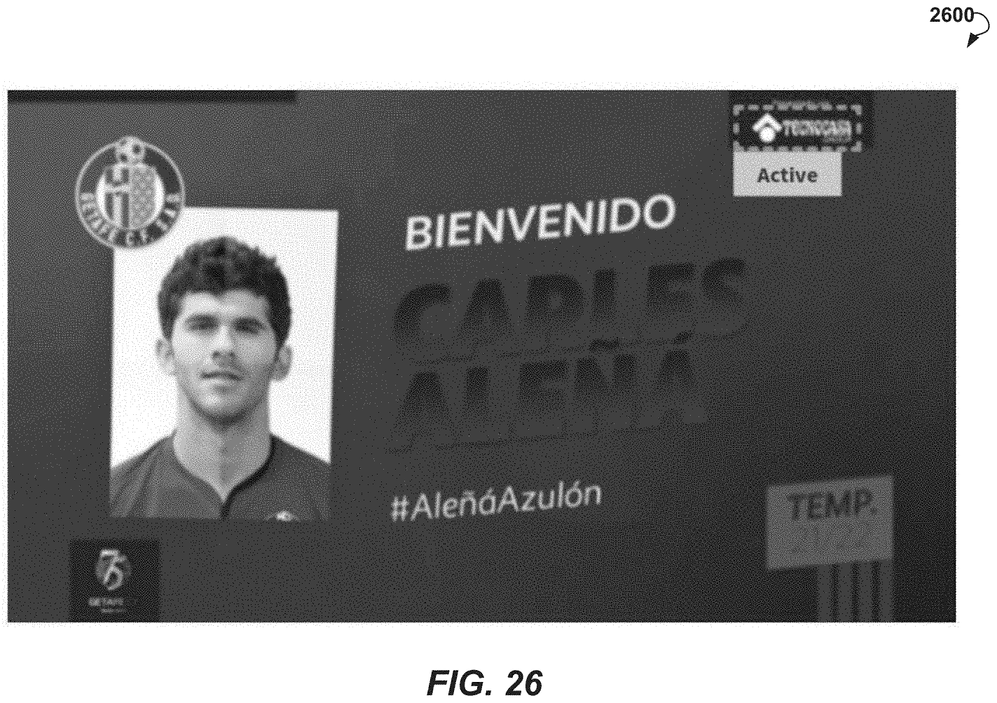

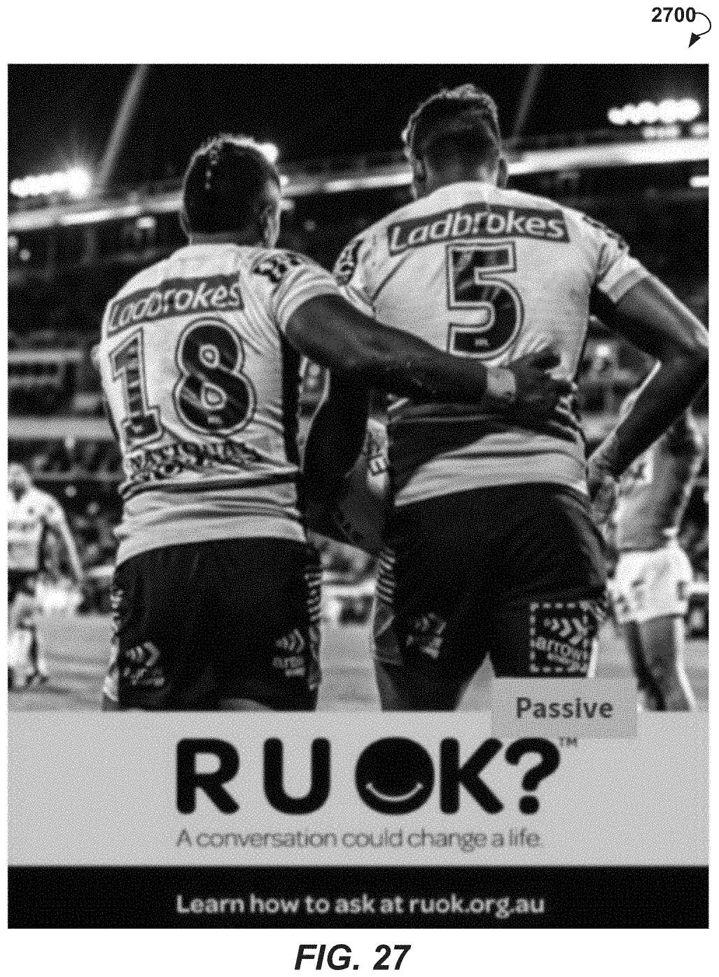

Active/Passive detection. The system further includes an active/passive detection module configured to classify the spot attribute of a brand exposure in the source media from social network feeds. FIG. 26 shows the active detection in the image. As shown in FIG. 26, the active detection indicates a brand exposure that was digitally added to the image or video before the content was published on social media, and not part of the originally captured content. FIG. 27 shows the passive detection in the image. As shown in FIG. 27, the passive detection indicates a brand exposure that was in the original image and has not been digitally inserted into the original image before posting to social media.

The input provided to the active/passive detection module includes one or more of the following: images or frames, metadata from the original post, and metadata from different layers of the system. The active/passive detection module accepts a single image, a set of images, or an individual video frame. Each image is fed into the active/passive detection module, in which the image undergoes standard preprocessing steps including resizing, normalization, and the like. After the preprocessing stage, the single image or a batch of the images are fed into the neural network for processing.

Besides the images or video frames, the active/passive detection module can receive additional metadata as the input. The metadata is a feature vector that encodes the following information: a brand ID, an entity ID, a scene type ID, an asset ID, a brand type, normalized coordinates, image dimensions, a media type, and so forth.

For each input image or video frame, the active/passive detection module can generate a feature vector to encode a list of floats to carry the information. The batch size of the feature vector is consistent with the batch of the input images/frames.

The output of the active/passive detection module is shown in FIG. 26 and FIG. 27. For each spotted brand in image or video, the active/passive detection module generates a tag to indicate if the spotting is an active spotting or a passive spotting.

In image spotting, the output of the active/passive detection module is a single tag to indicate the active or passive spotting. In video spotting, the output of the active/passive detection module includes a list of metadata for the metrics including: an exposure type, a brand name, spotted duration, spotted percentage in time, duration fractions, and so forth.

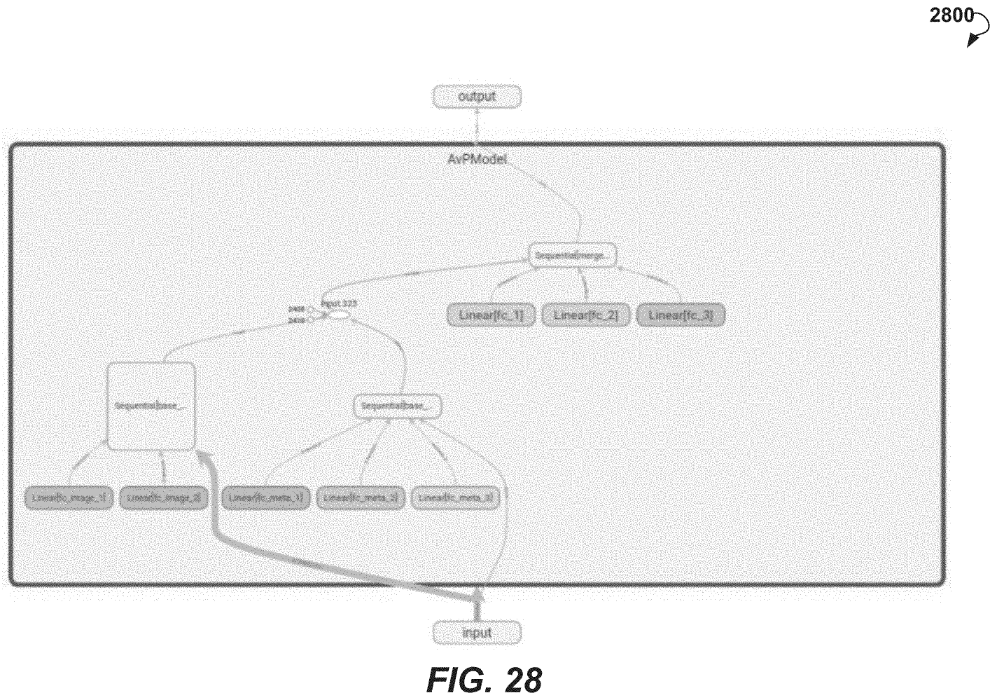

FIG. 28 is a schematic diagram showing a structure of a neural network used by the active/passive detection module. The model of the neural network consists of the following three main blocks: a base image model, a base meta model, and a merged model. The input of the image or video frame is fed into the base image model, and the base image model generates the output tensor. Similarly, the input of the feature vector is converted to tensor and then is fed into the base meta model. The base meta model outputs the feature tensor. The output from base image model and the base meta model is then concatenated into a single feature tensor, and then the single feature tensor is provided as an input to the merged model. Then, the merged model outputs the result given the input tensors.

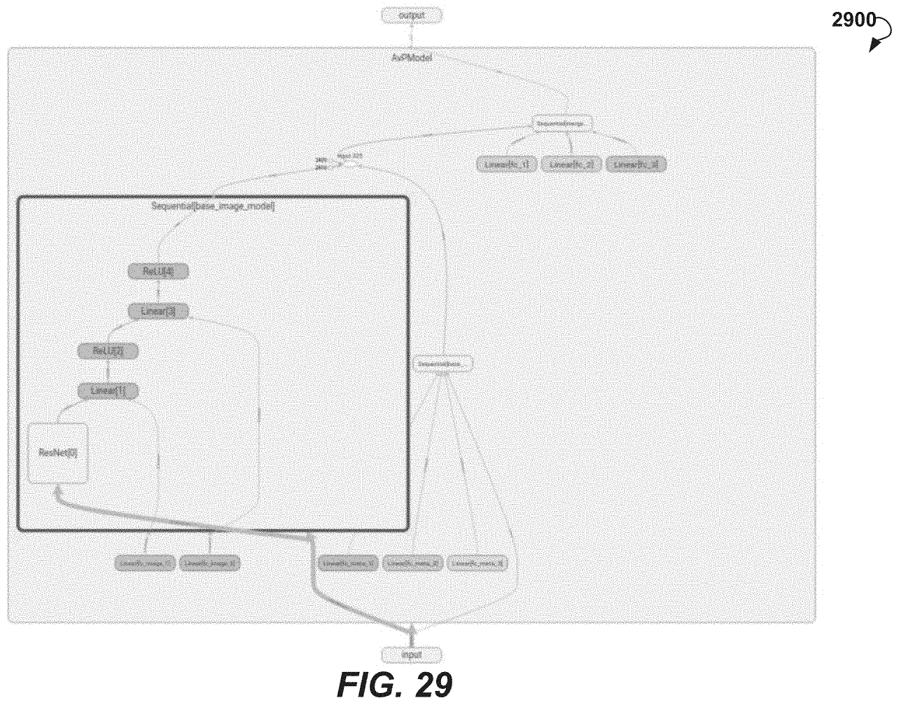

FIG. 29 is a schematic diagram showing a base image model. In the base image model, the image is fed into Residual Network (ResNet), with a resulting output of two additional linear layers with rectified linear unit (ReLU) activations. The ResNet block can be swapped into any other major neural networks, such as an inception network. The swap of the ResNet block can affect the overall model size, inference time, and the computational complexity. The RestNet block in FIG. 29 is shown for illustration purposes to show an example embodiment.

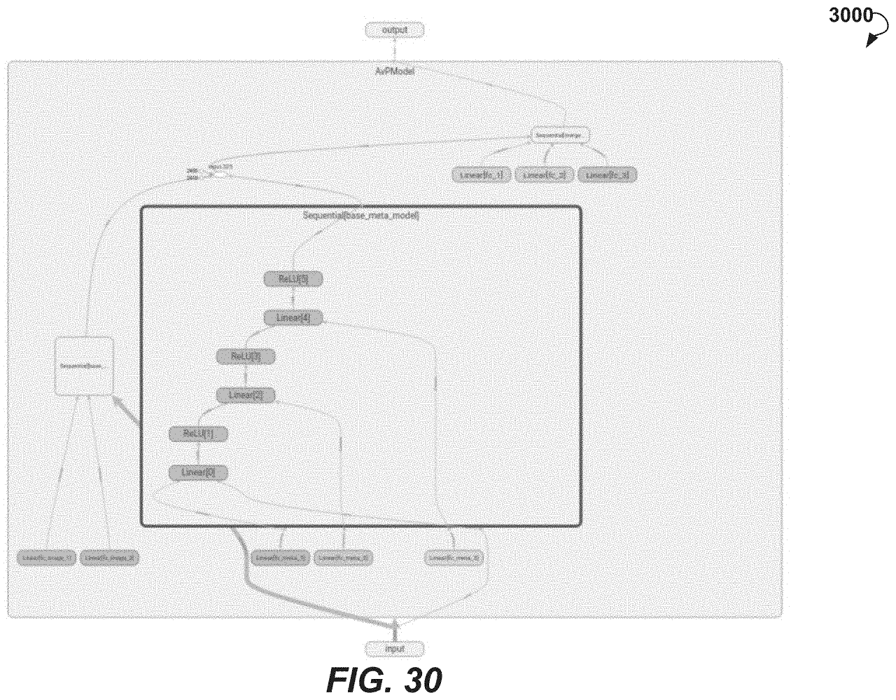

FIG. 30 is a schematic diagram showing a base meta model. The base meta model receives the encoded feature vector tensor and outputs a feature tensor in the same dimension of the base image model. The base meta model in FIG. 30 is an illustration of a three-layer case, each with a non-linear ReLU activation function. The number of layers in this meta model is flexible and three layers in FIG. 30 are shown for illustration purposes to show an example embodiment.

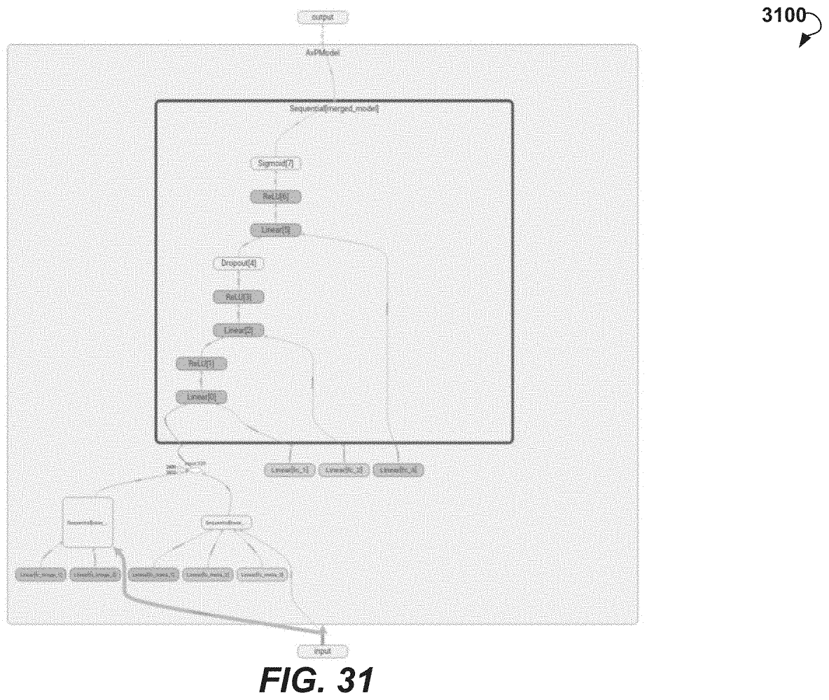

FIG. 31 is a schematic diagram showing a merged model. After merging two tensors from the base image model and the base meta model, the merged feature vector is the input of the merged model. As shown in FIG. 31, three fully connected layers paired with ReLU, one DropOut (a regularization technique for reducing overfitting in neural networks), and Sigmoid activation to the output.

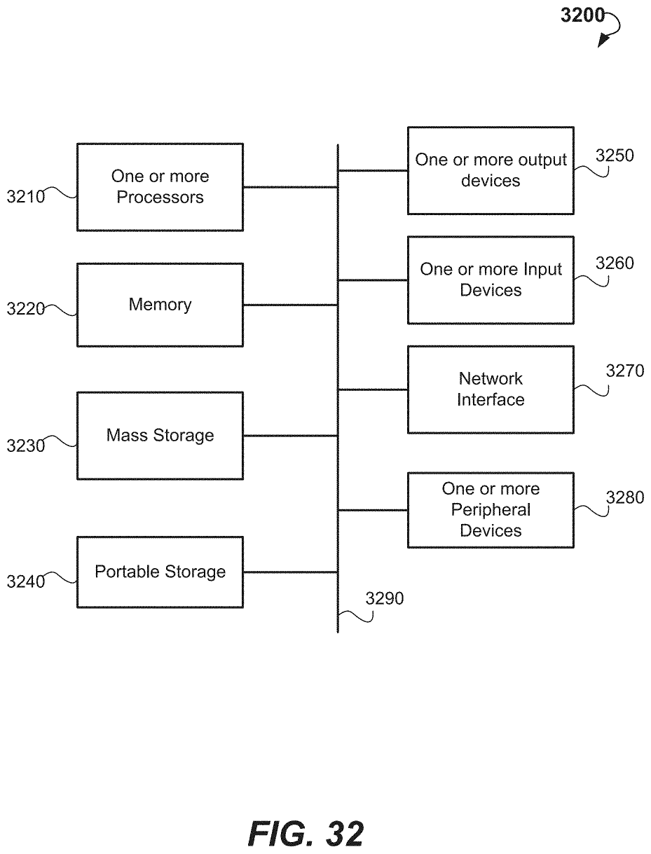

FIG. 32 illustrates an exemplary computing system 3200 that can be used to implement embodiments described herein. The computing system 3200 can be implemented in the contexts of the EMS workstation 105, root certificate 110, security device 120, voter device 230, mobile voting application 130, EMS 140, Election Registry 150, token issuer 220, and public ledger 160. The exemplary computing system 3200 of FIG. 32 may include one or more processors 3210 and memory 3220. Memory 3220 may store, in part, instructions and data for execution by the one or more processors 3210. Memory 3220 can store the executable code when the exemplary computing system 3200 is in operation. The exemplary computing system 3200 of FIG. 32 may further include a mass storage 3230, portable storage 3240, one or more output devices 3250, one or more input devices 3260, a network interface 3270, and one or more peripheral devices 3280.

The components shown in FIG. 32 are depicted as being connected via a single bus 3290. The components may be connected through one or more data transport means. The one or more processors 3210 and memory 3220 may be connected via a local microprocessor bus, and the mass storage 3230, one or more peripheral devices 3280, portable storage 3240, and network interface 3270 may be connected via one or more input/output buses.

Mass storage 3230, which may be implemented with a magnetic disk drive or an optical disk drive, is a non-volatile storage device for storing data and instructions for use by a magnetic disk or an optical disk drive, which in turn may be used by one or more processors 3210. Mass storage 3230 can store the system software for implementing embodiments described herein for purposes of loading that software into memory 3220.

Portable storage 3240 may operate in conjunction with a portable non-volatile storage medium, such as a compact disk (CD) or digital video disc (DVD), to input and output data and code to and from the computing system 3200 of FIG. 32. The system software for implementing embodiments described herein may be stored on such a portable medium and input to the computing system 3200 via the portable storage 3240.

One or more input devices 3260 provide a portion of a user interface. The one or more input devices 3260 may include an alphanumeric keypad, such as a keyboard, for inputting alphanumeric and other information, or a pointing device, such as a mouse, a trackball, a stylus, or cursor direction keys. Additionally, the computing system 3200 as shown in FIG. 32 includes one or more output devices 3250. Suitable one or more output devices 3250 include speakers, printers, network interfaces, and monitors.

Network interface 3270 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 3270 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 3280 may include any type of computer support device to add additional functionality to the computing system. The one or more peripheral devices 3280 may include a modem or a router.

The components contained in the exemplary computing system 3200 of FIG. 32 are those typically found in computing systems that may be suitable for use with embodiments described herein and are intended to represent a broad category of such computer components that are well known in the art. Thus, the exemplary computing system 3200 of FIG. 32 can be a personal computer, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

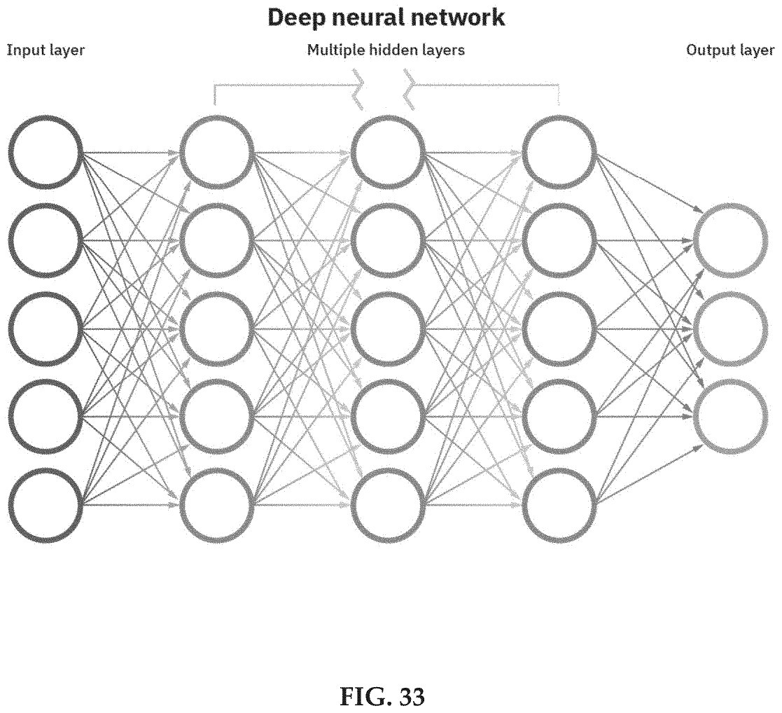

FIG. 33 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are composed of node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts. One of the most well-known neural networks is Google's search algorithm.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

Most deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as “backpropagation”. In fitting a neural network, backpropagation computes the gradient of the loss function with respect to the weights of the network for a single input—output example, and does so efficiently, unlike a naive direct computation of the gradient with respect to each weight individually. This efficiency makes it possible to use gradient methods for training multilayer networks, updating weights to minimize loss; gradient descent, or variants such as stochastic gradient descent, are commonly used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or “reverse mode”).

With respect to FIG. 33, according to exemplary embodiments, the system produces an output, which in turn produces an outcome, which in turn produces an input. In some embodiments, the output may become the input.

Thus, a sponsorship exposure metric system and a method for determining sponsorship exposure metrics are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A sponsorship exposure metric system comprising:
a processor configured to:
analyze a source media based on predetermined parameters, the source media including a sponsor message;
based on the analysis, determine sponsorship exposure metrics associated with the sponsor message, the sponsorship exposure metrics including at least one of the following: a brand exposure, an asset exposure, a scene type exposure, an active exposure, and a passive exposure; and
provide the sponsorship exposure metrics at least to a sponsor of the sponsor message; and
a memory communicatively coupled to the processor, the memory storing instructions executable by the processor.

2. The system of claim 1, wherein the source media includes one of the following: an image, a video, a text, and combinations thereof.

3. The system of claim 1, wherein the sponsor message includes one or any combination of the following: a brand name, a logo, a slogan, a text, a hashtag, a tagged mentioning, a text mentioning, a sports type, a league name, a team name, a social media comment, and a social media description.

4. The system of claim 1, wherein the analysis includes at least one of the following: an optical character recognition (OCR)-based scene classification of the source media, a description-based scene classification, and a generic machine learning based scene classification.

5. The system of claim 1, wherein the analysis is based on at least one of the following: a shared brand detection model, a generic brand detection model, and an entity specific brand detection model.

6. The system of claim 1, wherein the analysis is based on at least two or more of the following: a generic asset detection model, a shared asset detection model, and one or more sports-specific asset detection models.

7. The system of claim 1, wherein the analysis is based on a generic active passive detection model.

8. An intelligent secure networked messaging system configured by at least one processor to execute instructions stored in memory, the system comprising:
a data retention system and an analytics system, the analytics system performing asynchronous processing with a computing device and the analytics system communicatively coupled to a deep neural network;
the deep neural network configured to:
receive a first input at an input layer;
process the first input by one or more hidden layers;
generate a first output;
transmit the first output to an output layer;
map the first output to a sponsor.

9. The intelligent secure networked messaging system of claim 8, further comprising the sponsor is an outcome.

10. The intelligent secure networked messaging system of claim 9, further comprising the first outcome being transmitted to the input layer as input.

11. The intelligent secure networked messaging system of claim 10, further comprising the second outcome being transmitted to the input layer.

12. The intelligent secure networked messaging system of claim 8, wherein the first input is a source media.

13. The intelligent secure networked messaging system of claim 12, wherein the source media includes an image.

14. The intelligent secure networked messaging system of claim 12, wherein the source media includes a video.

15. The intelligent secure networked messaging system of claim 12, wherein the source media includes a text.

16. The intelligent secure networked messaging system of claim 12, further comprising the source media including a sponsor message.

17. The intelligent secure networked messaging system of claim 16, wherein the sponsor message includes a brand name.

18. The intelligent secure networked messaging system of claim 16, wherein the sponsor message includes a logo.

19. The intelligent secure networked messaging system of claim 16, wherein the sponsor message includes a slogan.

20. The intelligent secure networked messaging system of claim 9, wherein the first outcome from the sponsor is an amount of sales generated by the first output.
